(19) United States
(12) Patent Application Publication
(10) Pub. No.: US 2024/0059575 A1
(43) Pub. Date: Feb. 22, 2024

(54) Method of Bioammonia Production from Wastewater Through Application of Mass-Transfer Reaction Kinetics

(71) Applicants: Circular Upcycling, Redondo Beach, CA (US); Figure 8 Environmental, San Luis Obispo, CA (US)

(72) Inventors: Ken Tasaki, Redondo Beach, CA (US); Scott Harrison, San Luis Obispo, CA (US)

(73) Assignees: Circular Upcycling, Redondo Beach, CA (US); Figure 8 Environmental, San Luis Obispo, CA (US)

(21) Appl. No.: 18/446,417

(22) Filed: Aug. 8, 2023

Related U.S. Application Data
(60) Provisional application No. 63/474,357, filed on Aug. 9, 2022.

(51) Int. Cl. C01C 1/12

(52) U.S. Cl. CPC C01C 1/12

(57) ABSTRACT

Systems and methods are disclosed in which ammonia may be recovered efficiently from wastewater through the application of the mass-transfer reaction kinetic model. The recovery process may involve the stripping of NH₃ from wastewater by aeration and the absorption of this stripped NH₃ gas into a recovery solution by utilizing stoichiometric acid-base reactions and the operating parameters optimized by the model which facilitate both processes. Another step may be performed in which saturated solution comprising the recovered NH₃ may be further evaporated and liquefy to produce a pure bioammonia product. Applying the mass-transfer reaction kinetic to the recovery can not only enhance the NH₃ removal and recovery yield but also increase the NH₃ removal and recovery rate. Numerous operating parameters can be adjusted to maximize the recovery yield and recovery rate.

### CROSS-REFERENCE TO RELATED APPLICATIONS

This application claims priority to and the benefit of co-pending U.S. provisional patent application No. 63/474,357, filed Aug. 9, 2022, which is incorporated herein by reference in its entirety.

### FIELD OF INVENTION

This disclosure relates to the field of production of renewable, zero-carbon ammonia. More specifically, the disclosure relates to efficient recovery of ammonia from wastewater, including livestock manure liquid, and anaerobic manure digestate liquid, through the application of mass-transfer reaction kinetics.

### BACKGROUND OF THE INVENTION

The use of synthetic ammonia has been becoming increasingly unsustainable both environmentally and economically. Environmentally, synthesizing ammonia using natural gas (hereinafter “NG”) via the Haber-Bosch process is a high CO₂-emission generating process. The steam methane reforming process to split hydrogen for the NH₃ synthesis in the Haber-Bosch process generates 1.87 MT of CO₂ for every MT of NH₃; this process has become responsible for 1.8% of the global total CO₂ emissions. The major application of this synthetic ammonia is the production of nitrogen fertilizers (or “N fertilizers” or “biofertilizers”). According to USDA ERS, N fertilizer consumption has almost quadrupled since 1960 in the U.S. This trend is expected to continue, given the growing world population. As a result, the CO₂ emissions from synthetic ammonia production will be likely to rise.

Economically, the price of NG has increased more than 5-fold in 2020, compared to the year before. Consequently, the prices of N fertilizers have become 8-fold since then. The Haber-Bosch process is an energy-intensive process performed under a high pressure of ˜200 atm and a high temperature of ˜500° C., consuming 2% of the total energy supply in the world. NH₃ production processes that use less energy and generate fewer CO₂ emissions are thus more desirable. More importantly, the processes that do not use NG or any fossil fuels are increasingly sought-after.

The efforts to reduce the energy required for NH₃ productions have been made by using supercritical fluids (McGrady, G. S.; Wilson, C. “Procedures for Ammonia Production,” US 2010/0278708 A1 (2010)), absorbents for NH₃ separation with supported alkali metal salt (Malmali, M.; Le, G.; Hendrickson, J.; Prince, J.; McCormick, A. V.; Cussler, E. L. “Better Absorbents for Ammonia Separation,” ACS Sustainable Chem. Eng., 6, 5, 6536-6546 (2018)) and metal-organic frameworks (MOFs) (Snyder, B. E. R.; Turkiewicz, A. B.; Furukawa, H. et al. “A Ligand Insertion Mechanism for Cooperative NH₃ Capture in Metal-Organic Frameworks. Nature 613, 287-291 (2023)), and nano-particle catalysts (Carpenter, R. D.; Maloney, K. “System and Method for Ammonia Synthesis,” U.S. Pat. No. 9,272,920 B2 (2016)). Still, these processes commonly use NG as the source of H2.

US Patent Publication 2010/0040527 A1, the disclosure of which is incorporated herein by reference in its entirety, discloses a method to produce ammonia from biomass using oxygen and steam to generate a biosyngas (Randhava, et al., 2010). However, the process is similar to the Haber-Bosch method, i.e., using high temperatures and pressures. Likewise, the steam reforming process utilized generates CO₂ gas which is 30% of all the GHG gases produced by the process. The present disclosure relates to approaches that may limit if not minimize the use of fossil fuels.

Green Ammonia is receiving intense attention, as a renewable, zero-carbon fuel and a zero-carbon H₂ carrier. (Ghavam, S.; Vandati, M.; Wilson, I. A. G.; Styring, P. “Sustainable Ammonia Production Processes,” Front. Energy Res. (2021) 9,580808. doi: 10.3389/fenrg.2021.580808; “Ammonia: Zero-Carbon Fertilizer, Fuel, and Energy Store,” The Royal Society, February, 2020). However, employing water electrolysis to split H₂ from water requires a high energy consumption. A recent Oxford Report estimates that Green Ammonia is 3.7 times as expensive as Gray Ammonia, the conventional ammonia production based on the Haber-Bosch process using NG as the H₂ source (Patonia, A.; Poudineh, R. “Ammonia as a Storage Solution for Future Decarbonized Energy Systems,” The Oxford Institute for Energy Studies, November 2020.) Once H₂ is split from water, Green Ammonia still requires the energy-intensive Haber-Bosch process to produce NH₃.

As to be used in the disclosure herein, ammonia recovered from wastewater will be referred to as “bioammonia”. Bioammonia produced by any process, including the novel processes disclosed herein, have a wide range of applications. In addition to N fertilizers, ammonia is widely used a building block for materials such as fabrics, pesticides, plastics, explosives, and dyes. Recently, ammonia has been increasingly receiving attention as a zero-carbon energy carrier or fuel [Yousefi Rizi, H. A. Y.; Shin, D. “Green Hydrogen Production Technologies from Ammonia Cracking,” Energies, 15, 8246 (2022); MacFarlane, D. R. et al. “A Roadmap to the Ammonia Economy,” Joule 4, 1186-1205 (2020).].

Another carbon-free energy carrier/fuel, H₂, can be spitted from NH₃ by a catalyst (at 250° C., compared to ˜1,000° C. by steam reforming) and used as an energy source, e.g., for hydrogen fuel cells. As such, the conversion of NH₃ to H₂ is a very active area of research.

NH₃ is also used directly in NH₃ fuel cells such as NH₃-fed solid oxide fuel cells or NH₃-fed alkaline membrane fuel cells. Given the energy density of liquid NH₃, 50% more than liquid H₂, the direct NH₃ fuel cells are promising alternatives to H₂ fuel cells. Also, liquid NH₃ can be maintained at 25° C., while liquid H₂ requires −235° C. of temperature, which makes liquid NH₃ more attractive as energy storage or fuel.

The long-distance cargo shipping industry has been long preparing to use NH₃ as the carbon-neutral fuel for the fleets of their cargo vessels. Also, in their latest report, The World Bank identifies NH₃ as the most promising zero-carbon bunker fuel (The World Bank, 202). Compared to other zero-carbon fuels, ammonia has emerged as a strong and increasingly compelling candidate as the renewable energy-sourced fuel of the future.

With the global demand of ammonia being 140 million MT y⁻¹ in 2018, the total energy requiring the NH₃ production by electrolysis would have been 1,556 TWh, or about 63% of the estimated total wind and solar energy productions in the same year. This scenario leaves little room for other power applications that may rely on that energy.

Livestock animal manure contains non-negligible amounts of ammonia in the form of NH₄⁺, ranging from ˜0.1 wt % (cattle) to ˜0.6 wt % (poultry) (Manitoba Agriculture, Food and Rural Initiatives Growing Opportunities Centre, 2009.). When multiplied by the total heads of livestock animals in the world, the total amount of ammonia potentially recovered from animal manure is estimated to be as high as 42 million metric tons per year (Robinson, T. P.; Wint, G. R. W.; Conchedda, G.; Van Boeckel, T. P.; Ercoli, V.; Palamara, E.; Cinardi, G.; D'Aietti, L.; Hay, S. I.; Gilbert, M. “Mapping the Global Distribution of Livestock,” PLoS ONE, 9, e96 084 (2014), https://doi.org/10.1371/journal.pone.0096084.; “Livestock Waste Facilities Handbook,” Midwest Plan Services, Iowa State University, MWPS-18 Third Edition, 1993.).

This volume corresponds to about 30% of the total ammonia consumption in 2018. Hence, NH₄⁺ in livestock animal manure has the potential to replace a significant volume of Gray Ammonia. As the global livestock production grows, the global livestock manure volume is expected to expand by 14% between 2020 and 2029 (“World Food and Agriculture—Statistical Yearbook 2020,” FAO, Rome, 2020.).

Though livestock manure is often used as nutrients for growing crops, this practice has caused environmental problems such as groundwater contamination and eutrophication of rivers, lakes, and bays. For example, the application of liquid manure to the soil provides excess nitrogen and carbon, which in turn promotes heterotrophic activity. This in turn depletes the oxygen availability in the soil, thus favoring the creation of anaerobic microbes that release N₂O via denitrification. More than half (54.8%) of the total GHG (greenhouse gas) emissions from agricultural activities in the U.S. are due to the N₂O emissions from fertilizer applications to the soil. Of those N₂O emissions, 30-50% originate from animal manure applications, including organic nitrogen (Davidson, E. A. “The Contribution of Manure and Fertilizer Nitrogen to Atmospheric Nitrous Oxide Since 1860,” Nat. Geosci. (2009) 2, 659-662; Oenema et al., 2005 Oenema, O. N.; Wrage, G. L.; Velthof, J. W.; van Groenigen, J.; Kuikman, P. J. “Trends in Global Nitrous Oxide Emissions from Animal Production Systems.” Nutr. Cycling Agroecosyst. 72, 51-65 (2005)).

It would be desirable to recover this NH₃ from manure before its application to the soil, resulting in reduced GHG emissions.

Stripping/scrubbing processes to recover NH₃ from sources such as organic wastewater are commonly used in the art. There are many NH₃ stripping/scrubbing processes such as AMFER, Dorset LGL, and BIOCAST Process, to name a few (Vaneeckhaute, et al. “Nutrient Recovery from Digestate: Systematic Technology Review and Product Classification,” Waste Biomass Valor. 8, 21-40 (2017); Starmans, et al., Applied Engineering in Agriculture, 29(5): 761 29(5): 761-767 (2013); Pedros, et al., BIOCAST Process, U.S. Pat. No. 8,398,855 B1, (2013), the entire disclosure of which is incorporated herein by reference in its entirety).

Common among these NH₃ stripping/scrubbing processes is that the initial and operational costs are generally high. The CAPEX (capital expenses) has been estimated to be up to $17.5 million for 800 m³ day⁻¹ of flow rate with 2,500 NH₄-N mg L⁻¹ of the NH₄⁺ concentration [Vaneeckhaute et al., 2017]. Major technical bottlenecks in the current NH₃-stripping process include scaling and fouling of the packing materials, and the consequent high energy and chemical requirements. [Menkveld, H. W. H.; Broeders, E. “Recovery of Ammonia from Digestate as Fertilizer,” Water Practice & Technology (2018) 13, 382-387; Vaneeckhaute, et al. 2017).

One of the most serious disadvantages of these approaches is that the NH₃ removal by a stripping tower only occurs on the surface area of packing media which is hampered, given the large volume taken up by the media, reducing the interfacial area per volume of the stripping tower for the mass transfer. As a result, the NH₃ removal rate, the mass of NH₃ per volume removed over a given time, tends to be small. Articles, patents, or any publications reporting more than 400 mg L⁻¹ hr⁻¹ have not been found to be reported in the literature.

Membranes are another type of methodology often used for NH₃ recovery from manure. Membrane filtrations methodologies include, but are not limited to, ultrafiltration, nanofiltration, reverse osmosis (RO), electrodialysis, and membrane distillation. All membrane technologies, however, have a fundamental problem of membrane fouling, especially treating manure with a large content of organic matter, a main cause of fouling.

The U.S. Pat. No. 9,708,200 B2, the entire disclosure of which is incorporated herein by reference, discloses a process to recover NH₃ from manure liquid through a hollow-fiber gas-permeable membrane (Vanotti, M. B.; Szogi, A. A. “Systems and Methods for Reducing Ammonia Emissions from Liquid Effluents and Recovering the Ammonia,” U.S. Pat. No. 9,708,200 B2, Jul. 18, 2017.). Acid runs through inside the membrane to generate the pH gradient between inside and outside of the membrane which drives NH₃ from outside the membrane into inside.

One embodiment in this patent is to submerge the membrane into a lagoon to recover NH₃. However, the total suspended solid level is generally high in a lagoon. Under such an environment, the membrane is subjected to severe fouling. In order to avoid fouling, the total suspended solid (TSS) level in the wastewater should be extremely low. This patent provides no condition on the TSS level of the wastewater from which NH₃ is to be recovered. Further, once the pH gradient is equalized between inside and outside the membrane, there is no driving force to transfer NH₃ into the membrane. Accordingly, the NH₄⁺ concentration in the recovered NH₄⁺ solution is low, ˜0.2% (Vanotti, et al., 2017).

The U.S. Pat. No. 9,452,938 B2, the disclosure of which is incorporated by reference in its entirety, discloses a similar process in which a hydrophobic membrane is used to recover NH₃ from wastewater and the recovered NH₃ is mixed with acid (Morton Orentlicher; Mark Simon, “Ammonia Capture Recovery System,” U.S. Pat. No. 9,452,938 B2, Sep. 27, 2016.). Since this patent does not guide how low TSS should be in the wastewater before the membrane has a contact with the wastewater, this process has the same membrane fouling issue.

On the other hand, A US Patent Application US 2008/00539 A1, the entire disclosure of which is incorporated by reference herein, discloses the NH₃ recovery by aggressively using ion exchange resins (Fassbender A., “Ammonia Recovery Process,” US 2008/00539 A1, Mar. 6, 2008). Ion exchange resins are used in several steps to recover NH₃ and remove divalent and trivalent cations. The cost of such a process makes it prohibitable from practical usage.

EU Patent Application 91200922.2, the entire disclosure of which is incorporated herein by reference, discloses a method to recover NH₃ to form NH₄MgPO₄.6H₂O as struvite from manure digestate. However, controlling of pH and the Mg to PO₄ ratio, the key processing parameters, is difficult (Lorick, D.; Macura, B.; Ahlström, M. et al. “Effectiveness of Struvite Precipitation and Ammonia Stripping for Recovery of Phosphorus and Nitrogen from Anaerobic Digestate: a Systematic Review. Environ Evid 9, 27 (2020).).

If the concentration of nitrogen is higher than that of phosphate in the digestate, there will be an excess nitrogen leftover, which is another problem that arise from this approach. Additionally, struvite is solid, and hence, NH₃ needs to be separated from the solid which requires more energy than stripping of NH₃ from liquid.

A challenge of recovering ammonia from manure liquid is removing the undesirable materials in manure slurries without operational issues such as serious membrane fouling and concentrating ammonia without using high-energy processes such as reverse osmosis (RO).

On the other hand, once NH₄⁺ in the manure liquid is transferred to the NH₃ gas, the NH₃ recovery becomes less problematic, leaving behind undesirable materials such as pathogens or genetic materials in manure liquids. This Patent Publication simply uses a relatively straightforward process based on the thermodynamics and kinetics principles.

The U.S. Pat. No. 11,364,463, the entire disclosure of which is incorporated by reference herein, discloses a method to strip NH₃ from anaerobic digestate liquid (hereinafter “ADL”) by aeration and recover it by dissolving into the water (Rhu, et al., “Apparatus and Method for Recovering Effective Resources Including Nitrogen and Phosphorus,” U.S. Pat. No. 11,364,463 B2, Jun. 21, 2022). However, there are several shortcomings that impede its widespread usage.

First, U.S. Pat. No. 11,364,463 has a limited and less than ideal NH₃ removal yield, defined by the difference between the initial and final NH₄⁺ concentrations divided by the initial NH₄⁺ concentration. Secondly, as will be shown later in this disclosure, it only results in a limited NH₄⁺ absorption into the water in the recovery column. Third, U.S. Pat. No. 11,364,463 uses aeration to strip the NH₃ gas and send it to a liquefaction device to liquefy the gas. As will be demonstrated in EXAMPLE 8 of this disclosure, however, this method does not actually produce any liquid NH₃. The NH₃ gas aerated from ADL with the NH₄⁺ concentration in the digestate solution is too dilute to condense the aerated NH₃ molecules.

The specific density of liquid NH₃ is 0.86 g cc⁻¹ at −33° C. On the other hand, the specific density of the NH₃ gas at 20° C. is 0.71 g cc⁻¹. The NH₃ gas aerated from ADL having 2,000 mg L⁻¹ (2 g L⁻¹) would require a pump to send the gas to a pressurized tank to increase the gas density before liquefying the NH₃ gas. U.S. Pat. No. 11,364,463 does not include a pressurized tank or any other device to increase the NH₃ gas density.

In addition, when ADL is aerated, not only is the NH₃ gas stripped, but also other gases including N₂, O₂, and often CO₂ gases, are also mixed with the aerated NH₃ gas. When the gas mixture is sent to the cooling tower, the NH₃ gas tends to be carried away by other gases such as N₂ and O₂. When the mixture of these gases is cooled at temperatures between −77° C. and −33° C. at which the NH₃ gas can be liquefied, the N₂ and O₂ gases, however, stay as gas. Hence, these latter gases quickly go through the cooling tower, carrying the NH₃ gas. Fourth, the product of the NH₃ recovery by dissolving the stripped NH₃ gas into the water, is ammonium bicarbonate. This chemical is thermodynamically very unstable and not as valuable as other common fertilizers. Hence, it is not widely used; it would be much more ideal to produce a more usable fertilizer. In another embodiment of U.S. Pat. No. 11,364,463, a method is described to dissolve the aerated NH₃ gas into the water, clamming a 30% NH₄⁺ concentration in water. Indeed, the solubility of NH₃ in water is about 30% at 20° C. However, this may be the case when a pure NH₃ gas is used to dissolve in the water. In fact, experimentation has shown that when attempting to dissolve the aerated NH₃ gas into the water, more than 10% of NH₄⁺ concentration was never achieved.

In U.S. Pat. No. 11,364,463, the aerated gases from ADL include NH₃ and other gases such as N₂, O₂, and often CO₂. When these gases are bubbled into the water without acid, the other gases tend to carry away the NH₃ gas with them up to the atmosphere, given very little solubilities of N₂ and O₂, and the limited solubility of CO₂. As a result, the absorption of the NH₃ gas into the water is limited, as will be shown in EXAMPLE 2 of this disclosure.

More seriously, another embodiment described in U.S. Pat. No. 11,364,463 uses water as the coolant to maintain the cooling tower at temperatures between −77° C. and −33° C. Once the cooling water enters the cooling tower under this condition, the water freezes. Accordingly, it does not properly function as a coolant for the liquefaction of the NH₃ gas.

Attempts to replicate U.S. Pat. No. 11,364,463's claims at bench-scale experiments have failed to reproduce any results to support the claims of this patent, even with an organic solvent as the coolant, as is demonstrated under EXAMPLES 7 in this application.

Kinetics of NH₃ stripping by aeration has been discussed as a function of bubble size (Hossini, H.; Rezaeel, A.; Ayati, B.; Mahvi, A. H. “Off-gas treatment of ammonia using a diffused air stripper: a kinetic study,” Health Scope, August, 2015.). Mass transfer of the NH₃ gas to water has also been reported as a function of orifice diameters (Tao, W.; Ukwuani, A. T. “Coupling Thermal Stripping and Acid absorption for Ammonia Recovery from Dairy Manure: Ammonia volatilization kinetics and effects of temperature, pH and dissolved solids content,” Chem. Eng. J. 280, 188-196 (2015)). Controlling the mass-transfer kinetics of both NH₃ stripping and absorption simultaneously as functions of multiple operating parameters has rarely been disclosed in the past in the literature.

In order to control the mass-transfer kinetics, models for NH₃ stripping and absorption need to be developed. Once they are developed, they can be used to optimize the operating parameters to maximize the recovery yield and the kinetics.

### BRIEF SUMMARY

To solve these and other problems, systems and methods are presented in which the mass transfer rate of NH₃ stripped from wastewater by aeration may be substantially increased and in which the absorption mass transfer rate of stripped NH₃ into a recovery solution may also be substantially increased. The improvements in mass transfer rates in the ammonia extraction process from waste water provided by the present invention makes possible the development of economical ammonia production facilities for use on-site at dairy farms and other sources of waste water containing ammonium.

The stripping of NH₃ may take place in a stripping column while the absorption of the stripped NH₃ may take place in a recovery column. The stripping column and recovery column may be comprised by one or more sub columns housed in a column housing. The columns may also incorporate partitions and/or wall baffels to aid in the mass-transfer from gaseous to liquid and/or liquid to gaseous states. The ammonia in this solution may be evaporated and condensed in order to produce a pure and desirous bioammonia product.

Acid-base reactions may be utilized to facilitate and substantially improve the efficiency and effectiveness of the stripping and recovery processes. Specifically, a BrØnsted base, including Ca(OH)₂, Ca(HCO₃)₂, NaOH, Na₂CO₃, Na₂(HCO₃)₂, KOH, K₂CO₃, and K(HCO₃)₂ may be mixed with the filtered wastewater (this may define a stripping mixture) to enhance the stripping step, while the recovery solution may comprise a Brønsted acid, including HNO₃, H₂SO₄, H₃PO₄, C₆H₈O₅, formic acid, potassium acetate, trisodium phosphate, sodium acetate, and water, operative to enhance the recovery of stripped ammonia gas into the recovery solution. The amount of Brønsted acid/base supplied may be at least stoichiometric, or at least 10% more than stoichiometric, to the amount of ammonium ions in the wastewater or the amount of ammonia gas stripped respectively.

Applying mass-transfer reaction kinetics to one or more of the steps of these methods and systems can not only enhance the NH₃ removal and recovery yield, a measure of how much NH₃ can be recovered from a given amount of wastewater, but also increase the NH₃ removal and recovery rate, a measure of how fast NH₃ can be recovered, by adjusting multiple optimization parameters which include the amount of the base used for stripping, the amount of acid for absorption, the orifice diameter of air diffusers used in both of the columns, the diameter of both of the columns for a given column height, the number of diffuser per column (for each column), the number of air pumps, and more.

The wastewater may include, but it is not limited to, the wastewater from industrial plants, municipal wastewater, manure liquid, manure anaerobic digestate liquid, and combinations thereof. The wastewater may be filtered so as to isolate its liquid components from its solid components. Air can be supplied to the stripping column via one or more air diffusers, which can include sintered stone diffusers, membrane diffusers, sparger diffusers, and combinations thereof. Similar air diffusers may also be utilized in the recovery column in which they may supply the stripped ammonia gas from the stripping column to the recovery solution. The geometry and number of these air diffuser can be adjusted so as to optimize these stripping and recovery steps; these variables may depend on the geometry, particularly the diameter, of the stripping/recovery column they are associated with. When these parameters are optimized alongside the other operating parameters, the removal rate in the stripping step can be increased to nearly 1,300 mg L⁻¹ h⁻¹.

A saturated solution may be produced from the recovery column, which may itself be a desired product such as a fertilizer like ammonium sulfate. Alternatively, the saturated solution may be converted into bioammonia through evaporation and liquefaction. An evaporator and a liquefaction device can be used to carry out the evaporation and condensation steps respectively. The evaporator may comprise heating elements and mixing elements to aid in the evaporative processes. The liquefaction device may be fed a coolant operative to condense the ammonia. Such coolant may be circulated from a cryogenic storage which is given a supply of a cryogenic species, which may be dry ice or liquid nitrogen. The coolant may be iso-propanol, acetone, 1-, or 2-butanol, 2-butanone, ethanol, diethyl ether, heptane, n-hexane, pentane, 1-propanol, tetrahydrofuran, and triethyl amine. A further step may be carried in which the bioammonia produced from this liquefaction device may react with carbon dioxide under certain conditions in order to produce a urea product.

The stripping column may be accompanied by another stripping column with the same dimension. Once the ammonium concentration in the stripping column becomes plateau as a function of time, another stripping column may receive wastewater to continue tripping ammonia. This configuration allows a continuous operation without stopping the flow of wastewater. Also, the first stripping column may discharge the effluent and be refilled with a new batch of wastewater.

Similarly, the recovery column may be accompanied by another recovery column with the same dimension. Another recovery column may receive stripped ammonia gas when the recovery solution in the first recovery column reaches its maximum solubility. A similar benefit of a continuous process may be achieved in this configuration.

These and other aspects, embodiments, features, and advantages of these methods and systems will become better understood with regard to the following description, appended claims and accompanying drawings.

Any feature or combination of features described herein are included within the scope of the present methods and systems provided that the features included in any such combination are not mutually inconsistent as will be apparent from the context, this specification, and the knowledge of one of ordinary skill in the art. Additional advantages and aspects of the present methods and systems are apparent in the following detailed description and claims.

### BRIEF DESCRIPTION OF DRAWINGS

The foregoing aspects and the attendant advantages of the present methods and systems will become more readily appreciated by reference to the following detailed description, when taken in conjunction with the accompanying drawings, wherein:

FIG. 1 is a diagram of the steps of an exemplary NH₃ recovery process, using flushed manure as the feed wastewater;

FIG. 2 illustrates a schematic of an example of the production process of a saturated solution by using a stripping column and a recovery column;

FIG. 3 displays a schematic of an example of the process of using the saturated solution from the process of FIG. 2 to produce bioammonia by heating and liquefaction:

FIG. 4 is a perspective view an embodiment of a stripping column packed with sub columns, each of which is equipped with an air diffuser at the bottom of the column;€

FIG. 5 is a perspective view of one embodiment of a recovery column which incorporates a partition and wall baffles;

FIG. 6 is an exemplary configuration of a semi-continuous process consisting of a pair of stripping columns and a pair of recovery columns;

FIG. 7A is a schematic view showing an arrangement of sintered stone air diffusers and sparger pipe diffusers which may be incorporated into the bottom of a stripping or recovery column;

FIG. 7B is a schematic view showing another arrangement of sintered stone air diffusers and sparger pipe diffusers which may be incorporated into the bottom of a stripping or recovery column;

FIG. 8 illustrates a setup for a bench-scale stripping experiment testing a prior art method;

FIG. 9 shows the results of the pH of a carbonate solution according to the step of FIG. 8 as a function of time during aeration;

FIG. 10 displays the results of an experiment according to the setup of FIG. 8 in which the NH₄⁺ concentration is plotted as a function of time during the stripping process.

FIG. 11 shows the results of an experiment in which the NH₄⁺ concentration is plotted as a function of time during the stripping using two columns with differing column diameters;

FIG. 12 presents the results of an experiment in which the NH₄⁺ concentration is plotted as a function of time during the stripping using two types of air diffusers that differ in orifice diameter;

FIG. 13 illustrates an experimental setup for a bench-scale stripping and recovery experiment according to the methods and systems disclosed herein;

FIG. 14 shows the experimental data according to the experimental setup of FIG. 13 in which the NH₄⁺ concentration is plotted as a function of time during the stripping process under two conditions, one according to a prior art method and one according to the methods and systems disclosed herein;

FIG. 15 shows the results of an experiment in which the NH₄⁺ concentration is plotted as a function of time during the NH₃ absorption process into the recovery solution under two conditions, one according to a prior art method and one according to the methods and systems disclosed herein;

FIG. 16 plots the experimental results of the dependence of the normalized NH₄⁺ concentration on the stripping optimization variables K_{L,s}aₛ and

$$\frac{{Q}_{G , s} {H}_{s}}{{V}_{L , s}}$$

as a function of time for the stripping process

FIG. 17 plots the experimental results of the dependence of the normalized NH₄⁺ concentration on the recovery optimization variables K_{L,r}aᵣ and

$$\frac{{Q}_{G , r} {H}_{r}}{{V}_{L , r}}$$

as a function of time for the absorption process;

FIG. 18 illustrates an exemplary schematic of an apparatus to produce liquid NH₃ from the aerated NH₃ gas according to a prior art method; and

FIG. 19 illustrates one embodiment of an apparatus to produce liquid NH₃ from the evaporated NH₃ gas from a saturated solution according to the methods and systems disclosed herein.

Each figure has reference figures that are unique to the figure they are associated with, and as such like reference numerals to not necessarily correspond to like elements from one figure to the next.

### DETAILED DESCRIPTION

The detailed description set forth below is intended as a description of presently preferred embodiments of the methods and systems contemplated herein and is not intended to represent the only forms in which the presently contemplated systems and methods may be constructed and/or utilized. However, it is to be understood that the same or equivalent functions and results may be accomplished by different embodiments that are also intended to be encompassed within the spirit and scope of the presently contemplated subject matter, and additional variations of the present subject matter may be devised without departing from the inventive concept. The description itself is not intended to limit the scope of any patent issuing from this description. Rather, the inventors have contemplated that the claimed subject matter might also be embodied in other ways, to include different elements or combinations of elements similar to the ones described in this document, in conjunction with other present or future technologies.

An embodiment of the present disclosure includes a method to produce bioammonia by recovering NH₃ from wastewater. Wastewater may be a mixture that contains ammonia and/or ammonium ions, and as such it may include, but is not limited to, industrial wastewater, municipal wastewater, livestock manure liquid, anaerobic manure digestate liquid, non-manure based anaerobic digestate liquid, and combinations thereof.

A system to produce bioammonia according to the methods disclosure herein may comprise two types of columns: one for the NH₃ stripping where the step of stripping ammonia gas may take place, to be referred to as the stripping column, and another for the NH₃ absorption into a recovery solution where the step of recovering the stripped ammonia gas through absorption may take place, to be referred to as the recovery column,. The product may be a saturated solution which can be used as is, or alternatively processed further into bioammonia. The system may further comprise an evaporator and a liquefaction device which may act upon the saturated solution produced from the recovery column to produce this desirous bioammonia product.

Before detailing these systems and methods, models for the mass-transfer reaction kinetics of the NH₃ stripping and absorption processes will be developed and discussed first. Then, those models will be used to optimize the various operating parameters so as to describe how the systems and methods herein may be arrived and the preferred embodiments. Acid-base reactions for both NH₃ stripping and absorption processes will expressed as follows, respectively in Equations 1 and 2:

NH₄⁺+XB→NH₃+BH+X⁺ (1)

and NH₃+AH→NH₄⁺+A⁻ (2)

where XB and AH refer to a Brønsted base and acid, respectively. XB is preferably a strong base, including, but is not limited to, X(OH)ₙ, XCO₃, and XHCO₃, where X can be, but is not limited to, Ca, K, and Na, and n=1 or 2 depending on the counter cation (as would be understood by those skilled in the art). AH is preferably a strong acid including, but is not limited to, sulfuric acid, nitric acid, phosphoric acid, and organic acids. As will soon be shown, the Brønsted base can be mixed with the wastewater fed to the stripping column and the Brønsted acid can be mixed with the stripped ammonia gas fed to the recovery column to substantially increase the effectiveness of the processes associated with both of those columns. NH₄⁺ in Equations 1 and NH₃ in Equations 2 may act as an acid and a base respectively. Hence, Equations 1 and 2 are acid-base reactions. Acid-base reactions are known to be thermodynamically favorable, exothermic, and kinetically fast, provided sufficient concentrations of the base (XB) and acid (AH). Explicitly incorporating the acid-base reactions to capture NH₃ in the wastewater and absorb the captured NH₃ through the reactions, hence increasing the efficiency of the NH₃ stripping and absorption processes simultaneously, is understood to be novel. The NH₃ gas may be stripped by Equation 1 via aeration of a stripping mixture in the stripping column, and this stripped NH₃ gas may be absorbed into an acidic recovery solution by Equation 2 in the recovery column.
The removal/recovery yield (η_{s/r}) and the removal/recovery rates (ρ_{s/r}) will be defined as follows in Equations 3-5:

ηₛ=100{1−([NH₄⁺]ₛ^{f})/[NH₄⁺]ₛⁱ)} (3)

ηᵣ=100([NH₄⁺]ᵣ^{f})/[NH₄⁺]ₛⁱ) (4)

ρ_{s/r}=a([NH₄⁺]_{s/r}ⁱ−[NH₄⁺]_{s/r}^{f})/tₚ (5)

where [NH₄⁺] represents the NH₄⁺ concentration, the subscripts “s” and “r” refer to the NH₄⁺ concentration in the stripping step and that in the recovery step, respectively. The superscripts “i” and “f” refer to the initial and final concentrations of NH₄⁺ respectively, and as such [NH₄⁺]ₛ^{f}≤[NH₄⁺]ₛⁱ and [NH₄⁺]ᵣ^{f}≤[NH₄⁺]ₛⁱ. a=1 and −1 for the stripping and recovery processes, respectively. The removal/recovery yield (η_{s/r}) and the removal/recovery rates (ρ_{s/r}) from these Equations 3 through 5 will be referred to as “performance parameters”. These performance parameters will ideally be maximized so that the largest amount of ammonia can be extracted from a given amount of wastewater in the quickest amount of time. tₚ is the time required for the NH₄⁺ concentration to become a plateau, or approximately reach steady state.

These systems and methods may yield particularly effectual results by optimizing one or more operating parameters. These operating parameters may include, but are not limited to, the concentrations of the Brønsted base in the stripping column, the concentration of the Brønsted acid in the recovery column, the orifice diameter of one or more aeration diffusers in the stripping and/or recovery columns, the diameter of the stripping and/or recovery column for a given column height, the surface area per length of the one or more air diffusers, the number of air diffusers per column, the number of air blowers per column, the ratio of the air flowrate to the volume in each column, and more. The performance parameters, ηᵣ and ρ_{s/r}, may ideally be maximized using the mass-transfer reaction kinetics models and adjusting the operating parameters.

For both cases, Equations 1 and 2, the chemical reactions may occur very fast; hence, the processes may be primarily controlled by the more physical process of the mass transfer of NH₃ between the liquid state and the air bubbles. Then, Equations 1 and 2 become a liquid-to-gas transfer process: the transfer of NH₃ from the NH₄⁺ solution to the air bubble in the stripping column for Equations 1 and the transfer of NH₃ from the air bubbles to an aqueous acid solution for Equations 2.

Using the two-film theory, the mass balance of NH₃ from liquid to gas may be written as follows in Equation 6:

$$- {V}_{L , s} \frac{{d [ N {H}_{3} ]}_{L}}{d t} = {F}_{L \to G} \qquad ( 6 )$$

where [NH₃]_{L}, V_{L,s}, and F_{L→G} refer to the NH₃ concentration in the liquid, the volume of stripping solution, and the mass transfer rate of NH₃ from the solution to the gas bubbles generated by air diffusers, respectively, according to Matter-Müller et al. [Matter-Müller, C.; Gujer, W.; Giger, W. “Transfer of Volatile Substances from Water to the Atmosphere,” Water Research, 15, 1271-1279 (1981).].

According to Matter-Müller, F_{L→G} is defined as follows in Equation 7:

$${F}_{L \to G} = {Q}_{G , s} {{H}_{s} [ N {H}_{3} ]}_{L} \{ 1 - exp ( - \frac{{K}_{L , s} {a}_{s} {V}_{L , s}}{{H}_{s} {Q}_{G , s}} ) \} \qquad ( 7 )$$

where Q_{G,s}, Hₛ, K_{L,s}, and aₛ represent the air flowrate at the inlet to the stripping column, Henry's law constant for NH₃ in the stripping column, the mass transfer coefficient of NH₃ from liquid to the air bubble, and the interface area per unit volume of liquid in the stripping column, respectively. [Matter et al.]

It can be seen that in Equation 1, increased [NH₃]_{L} could be achieved by the Brønsted base shifting the reaction of Equation 1 to the right side via the base taking a proton away from NH₄⁺, thus raising the value of F_{L→G}.

Hₛ is defined by Matter et al. as follows in Equation 8:

$${H}_{s} = \frac{{[ N {H}_{3} ]}_{G}}{{[ N {H}_{3} ]}_{L}} \qquad ( 8 )$$

where [NH₃]_{G} and [NH₃]_{L} represent the NH₃ concentrations in the gas and liquid phases, respectively. Hₛ and K_{L,s} depend on pH and temperature, the latter of which may ideally be the ambident temperature of the system (Li, S.; Fan, J.; Xu, S.; Li, R.; Luan, J. “The Influence of pH on Gas-Liquid Mass Transfer,” Chem. Ind. Chem. Eng. Q. 23 (3) 321-327 (2017); Wilson, G. M. “A New Correlation of NH₃, CO₂, and H₂S Volatility Data from Aqueous Sour Water Systems,” EPA-600/2-80-067, 1980; Kim, E. J.; Kim, H.; Lee, E. “Influence of Ammonia Stripping Parameters on the Efficiency and Mass Transfer Rate of Ammonia Removal,” Appl. Sci. 11, 441 (2021)).

[NH₄⁺] is more easily measured, especially in a stripping column, when compared to [NH₃]_{L}. Hence, [NH₃]_{L} will be replaced by [NH₄⁺] in Equation 6.

Solving the differential equation of Equation 6 with the boundary conditions of [NH₄⁺]=[NH₄⁺]^{t} at t=t and [NH₄⁺]=[NH₄⁺]⁰ at t=0 gives the following Equation 9:

$$- ln ( \frac{{[ N {H}_{4}^{+} ]}^{t}}{{[ N {H}_{4}^{+} ]}^{0}} ) = \frac{{Q}_{G , s} {H}_{s}}{{V}_{L , s}} \{ 1 - exp ( - \frac{{K}_{L , s} {a}_{s} {V}_{L , s}}{{H}_{s} {Q}_{G , s}} ) \} t \qquad ( 9 )$$

Plotting the negative logarithm of the concentration ratio in Equation 9 against t gives a straight line with the following slope in Equation 10:

$${σ}_{s} = \frac{{Q}_{G , s} {H}_{s}}{{V}_{L , s}} \{ 1 - exp ( - \frac{{K}_{L , s} {a}_{s} {V}_{L , s}}{{H}_{s} {Q}_{G , s}} ) \} \qquad ( 10 )$$

where σₛ is the mass transfer rate per unit volume for the stripping process. This value is ideally maximized, as a higher value corresponds to a faster and thus more efficient rate of stripping ammonia gas. Therefore, from experiments under different conditions using different sets of operating parameters, the right-side values of Equation 10 are obtained for a given set of V_{L,s}, Q_{G,s}, Hₛ, aₛ, and K_{L,s}. Equation 10 teaches us that in order to increase σₛ, the air flowrate and aₛ should be higher, and the Brønsted base should have a higher pH to increase the concentration of NH₃ in the liquid, which in turn raises both Hₛ, and K_{L,s}.

There are five variables in Equation 10: V_{L,s}, Q_{G,s}, Hₛ, aₛ, and K_{L,s}. These variables can be consolidated to two combined variables:

$$\frac{{Q}_{G , s} {H}_{s}}{{V}_{L , s}}$$

and K_{L,s}aₛ. Accordingly, the operating parameters can be optimized to increase the value of these two combined variables. These combined variables may be referred to as stripping optimization variables.

As would be understood by those skilled in the art, K_{L,s}. aₛ can be increased by generating a larger number of smaller air bubbles per volume. Smaller air bubbles tend to have a longer retention time in a column which is favorable for both stripping and absorption of NH₃. The orifice diameter of air diffuser may primarily determine the size of air bubbles. The number of air bubbles per volume may depend on the number of diffuser orifices across the column they are associated with. Hence, the diameter of a column also matters for a given column height, as a larger diameter means that more air diffusers can be used. In general, a higher ratio of the column height to the diameter tends to give rise to an increased axial dispersion coefficient (Alvaré, J.; Al-Dahhan, M. H., “Liquid Phase Mixing in Trayed Bubble Column Reactors,” Chem. Eng. Scien., 61, 1819 (2006)). aₛ also may depend on the surface area per length of the diffuser, provided that the surface area is covered by the orifice pores.

As to

$$\frac{{Q}_{G , s} {H}_{s}}{{V}_{L , s}}$$

Q_{G,s} should ideally be maximized for a given V_{L,s}. In reality, V_{L,s} is often determined by the flowrate of wastewater at a plant or a livestock farm. Q_{G,s}, then, can be chosen to maximize

$$\frac{{Q}_{G , s}}{{V}_{L , s}} .$$

Still, the ratio of the air flowrate to the volume is determined more or less based primarily on the economy and the amount of wastewater feed available, since a high Q_{G,s} can be costly.

That leaves Hₛ as a more easily adjustable parameter. It is well-known in the art that the equilibrium between [NH₃]_{G} and [NH₃]_{L} shifts towards [NH₃]_{G} at higher values of pH. When enough base is present in the stripping step to shift Equation 1 completely to the right side, a sudden increase in [NH₃]_{L} raises [NH₃]_{G} rapidly, increasing Hₛ quickly in the beginning of the stripping. The high concentration of the base has a similar effect on K_{L,s}. This cascade process, along with the increased K_{L,s}, helps σₛ increase immediately. The high mass transfer rate, in the beginning of this process, helps reduce the bulk of the NH₄⁺ concentration in the stripping column within a short period, promoting the high removal rate in mg L⁻¹ h⁻¹. Accordingly, the optimization variables can be optimized by changing the aforementioned operating parameters to maximize ηᵣ and ρᵣ.

Since Equation 10 establishes the relationship between the mass transfer rate and the stripping optimization variables, which are functions of the operating parameters, it can not only provide guidance for the ideal of the operating parameters, but also significantly reduce the potentially lengthy time required to ascertain the ideal operating parameters to result in an increased mass transfer rate. Through rearrangement, Equation 9 becomes Equation 11 as follows:

[NH₄⁺]^{t}=[NH₄⁺]⁰e^{-σ}^{ₛ}^{t} (11)

Equation 11 describes the reduction of [NH₄⁺] as a function of time by aeration based on Equation 1. Still, Equation 11 is for an ideal situation where all the initial NH₄⁺ concentration is removed, which may not always be the case. Then, Equation 11 may be written more realistically as follows in

$$\begin{matrix}Equation 12 & \\ [ {NH}_{4}^{+} ] = {[ {NH}_{4}^{+} ]}^{0} \{ 1 - \frac{{η}_{s}}{100} ( 1 - {e}^{- {σ}_{s} t} ) \} & ( 12 )\end{matrix}$$

Equation 12 gives

$${[ N {H}_{4}^{+} ]}^{t} = {[ N {H}_{4}^{+} ]}^{0} at t = 0 {and [ {NH}_{4}^{+} ]}^{t} = {[ N {H}_{4}^{+} ]}^{0} ( 1 - \frac{{η}_{s}}{100} )$$

at t→∞ both of which are consistent with Equation 11 when ηₛ is equal to 100%. ηₛ primarily may depend on the condition of the solution from which NH₄⁺ is removed. For example, if a sufficient mass of the BrØnsted base is supplied, Equation 1 should go completely to the right side, leaving little NH₄⁺ concentration in the stripping step. On the other hand, σₛ as determines the rate of the stripping. If the experiment follows Equation 12, the information on σₛ can be obtained for each set of the stripping optimization variables K_{L,s}aₛ and

$$\frac{{Q}_{G , s} {H}_{s}}{{V}_{L , s}}$$

from the experiments by the same procedure as described above by using the following Equation 13:

$$ln [ ( \frac{{η}_{s}}{100} ) ( \frac{{[ N {H}_{4}^{+} ]}^{t}}{{[ N {H}_{4}^{+} ]}^{0}} - 1 + \frac{{η}_{s}}{100} ) ] = - {σ}_{s} t \qquad ( 13 )$$

Plotting the left hand of Equation 13 against t gives a straight line with a slope, σₛ. After a number of experiments to cover enough ranges of the stripping operating parameters within reasonable ranges, a relationship between σₛ and the stripping operating parameters can be established using Equations 5, 10, 12, and 13. From the relationship, the information on the concentration of the Brønsted base, the orifice diameter of the air diffuser, the number of air diffusers in the column, the ratio of the column diameter over the height, and the surface area per length of the air diffusers, and the ratio of the air flowrate over the liquid volume can be obtained for the stripping process. Using those relationships, Equations 3, 5, 10, 12, and 13, it is possible to find a set of stripping operating parameters that gives the best set of ηₛ and ρₛ.

The same analysis will now be performed on the step of recovering the stripped ammonia gas by absorption. As to Equation 2, the gas-to-liquid mass transfer may be written as follows in Equation 14:

$$- {V}_{L , r} \frac{d [ N {H}_{4}^{+} ]}{d t} = {F}_{G \to L} \qquad ( 14 )$$

where V_{L,r} and F_{G→L} refer to the volume of the recovery solution used and the mass transfer rate of stripped NH₃ in the gas bubbles to NH₄⁺ in the recovery solution, respectively. The latter may be written as follows as Equation 15:

$$\begin{matrix}{F}_{G \to L} = {Q}_{G , r} {H}_{r} ( {[ N {H}_{4}^{+} ]}_{s a t} - \\ [ {NH}_{4}^{+} ] ) \{ 1 - exp ( - \frac{{K}_{L , r} {a}_{r} {V}_{L , r}}{{H}_{r} {Q}_{G , r}} ) \} \\ = {Q}_{G , r} ( \frac{{η}_{r}}{100} \times {\frac{{η}_{s}}{100} [ N {H}_{4}^{+} ]}_{s}^{i} - [ N {H}_{4}^{+} ] ) \\ \{ 1 - exp ( - \frac{{K}_{L , r} {a}_{r} {V}_{L , r}}{{H}_{r} {Q}_{G , r}} ) \}\end{matrix} \qquad ( 15 )$$

Where Q_{G,r}, Hᵣ, K_{L,r}, and aᵣ represent the gas flowrate at the inlet to the stripping column, Henry's law constant for NH₃ in the recovery column, the mass transfer coefficient of NH₃ from the air bubble to the liquid state, and the interface area per unit volume of liquid of the recovery solution, respectively.

At a low pH, [NH₄⁺] increases, while [NH₃]_{G} decreases, which in turn accelerates F_{G→L}. Accordingly, Henry's constant is expressed as follows:

$${H}_{r} = \frac{{[ N {H}_{3} ]}_{L}}{{[ N {H}_{3} ]}_{G}} \qquad ( 16 )$$

[NH₄⁺]ₛₐₜ is the NH₄⁺ concentration at the saturation point or the final NH₄⁺ concentration in the recovery column which is replaced by

$$\frac{{η}_{r}}{100} \times {\frac{{η}_{a}}{100} [ N {H}_{4}^{+} ]}_{s}^{i}$$

using Equation 4. For Q_{G,r} and aᵣ, the same argument can be made as for Q_{G,s} and aₛ, as discussed above.

As to Hᵣ and Kᵣ, a Brønsted acid with a low pH may be used to increase these variables. What Equation 2 enables us to recognize is that increasing the proton concentration at the interface between the liquid and the air bubbles is beneficial since when the NH₃ gas molecules inside the bubbles have contact with the interface, they can immediately react with the protons outside the bubbles to be dissolved as NH₄⁺, hence raising F_{G→L}.

Solving the differential equation of Equation 14 with the boundary conditions of

$${[ N {H}_{4}^{+} ]}^{t} = \frac{{η}_{r}}{100} \times {\frac{{η}_{a}}{100} [ N {H}_{4}^{+} ]}_{s}^{i}$$

at t→∞ and [NH₄⁺]^{t}=0 at t=0 gives the following Equation 17:

$${[ N {H}_{4}^{+} ]}^{t} = \frac{{η}_{r}}{100} \times {\frac{{η}_{a}}{100} [ N {H}_{4}^{+} ]}_{s}^{i} ( 1 - {e}^{- {σ}_{r} t} ) \qquad ( 17 )$$

where σᵣ is expressed as follows in Equation 18:

$${σ}_{r} = \frac{{Q}_{G , r} {H}_{r}}{{V}_{L , r}} \{ 1 - exp ( - \frac{{K}_{L , r} {a}_{r} {V}_{L , r}}{{H}_{r} {Q}_{G , r}} ) \} \qquad ( 18 )$$

where σᵣ is the mass transfer rate per unit volume for the recovering process. Equation 17 combines the stripping and absorption processes for the reaction kinetics of the multiphase liquid-to-gas and then the gas-to-liquid mass-transfers by one equation. [NH₄⁺]ᵣ^{t} thus depends not only the kinetics of the absorption, but also that of the stripping. Q_{G,r}, Hᵣ, and K_{L,r} of σᵣ in Equation 18 are also functions of the kinetics in the stripping. Now the NH₃ recovery can be properly described, which is a result of not only the mass transfer in the stripping process, but also that of the absorption process. Thus, from experiments under different conditions using different sets of operating parameters, the values of the right side of Equation 18 may be obtained for a given set of V_{L,r}, Q_{G,r}, Hᵣ, aᵣ, and K_{L,r}. Equation 18 teaches us that in order to increase σᵣ, the ratio of the gas flowrate to the volume, aᵣ should be preferably high, and the Brønsted acid should preferably have a low pH in order to increase the concentration of protons in the liquid, which in turn raises both Hᵣ and K_{L,r}.

There are five variables in Equation 18: V_{L,r}, Q_{G,r}, Hᵣ, aᵣ, and K_{L,r}. These variables can be consolidated to two combined variables:

$$\frac{{Q}_{G , r} {H}_{r}}{{V}_{L , r}}$$

and K_{L,r}aᵣ. Accordingly, the operating parameters may be optimized to increase these two combined variables. This set of combined variables may be referred to as recovery optimization variables.

As would be understood by those skilled in the art, K_{L,r}. aᵣ can be increased by generating a large number of small air bubbles per volume. Small air bubbles may have a longer retention time in the column which is favorable for the absorption of NH₃ into the acidic recovery solution. The orifice diameter of air diffuser may primarily determine the size of air bubbles. The number of air bubbles per volume may depend on the number of air diffuser orifices used across the recovery column. Hence, the diameter of the recovery column matters for a given column height, as a larger diameter gives more space for more air diffusers. aᵣ also may depends on the surface area per length of the diffuser, provided that the surface area is covered by the orifice pores.

As to

$$\frac{{Q}_{G , r} {H}_{r}}{{V}_{L , r}} ,$$

Q_{G,r} may be maximized for a given V_{L,r}. In reality, V_{L,r} is often determined by the flowrate of wastewater at a plant or a livestock farm. Q_{G,r}, then, is chosen to maximize

$$\frac{{Q}_{G , r}}{{V}_{L , r}} .$$

Still, the ratio of the air flowrate to the volume is determined more or less based primarily on the economy, since a high Q_{G,r} can be costly.

That leaves Hᵣ as a more easily adjustable parameter. It is well-known in the art that the equilibrium between [NH₃]_{G} and [NH₃]_{L} shifts towards [NH₃]_{L} at lower values of pH. When enough acid is present in the recovery column to shift Equation 2 completely to the right side, a sudden increase in [NH₃]_{L} may raise Hr rapidly at the beginning of the recovery. The high concentration of the acid has a similar effect on K_{L,r}. This process, along with the increased, K_{L,r}, may accelerate the value of σᵣ immediately. The high mass transfer rate in the beginning of the process helps reduce the bulk of the NH₄⁺ concentration in the recovery step within a short period, promoting the high removal rate in mg L⁻¹ h⁻¹.

Accordingly, the recovery optimization variables can be optimized by changing the operating parameters such as the concentration of the Brønsted acid, the orifice diameter of the air diffuser, the number of diffusers in the column, the ratio of the column diameter over the height, and the surface area per length of the diffuser, the ratio of the air flowrate over the liquid volume among others to maximize ηᵣ and σᵣ.

Since Equation 18 establishes the relationship between the mass transfer rate and the recovery optimization variables, which are functions of the operating parameters, it can not only provide guidance for the ideal values of the operating parameters, but also significantly reduce the potentially lengthy time required to ascertain the ideal values of the operating parameters to increase the mass transfer rate.

Rearrangement of Equation 17 gives the following Equation 19:

$$ln [ 1 - \frac{{[ {NH}_{4}^{+} ]}^{t}}{{\frac{{η}_{r}}{100} [ {NH}_{4}^{+} ]}_{s}^{i}} ] = - {σ}_{r} t \qquad ( 19 )$$

Plotting the left side of Equation 19 against t gives a straight line with the slope, σᵣ. As mentioned above, after a number of experiments to cover enough ranges of the operating parameters, a relationship between ηᵣ or ρᵣ and the operating parameters can be established, using Equations 4, 5, 17, 18 and 19.

From the relationship, the information on the concentration of the Brønsted acid, the orifice diameter of the air diffuser, the number of air diffusers in the column, the ratio of the column diameter over the height, and the surface area per length of the air diffusers, and the ratio of the air flowrate over the liquid volume can be obtained for the absorption process. Using the relationships, Equations 4, 5, 17, 18 and 19, it is possible to find a set of operating parameters that maximize ηᵣ and ρᵣ.

Now that these models have been developed, the present disclosure will turn to the Figures and describe how methods and systems for bioammonia production may be arrived at.

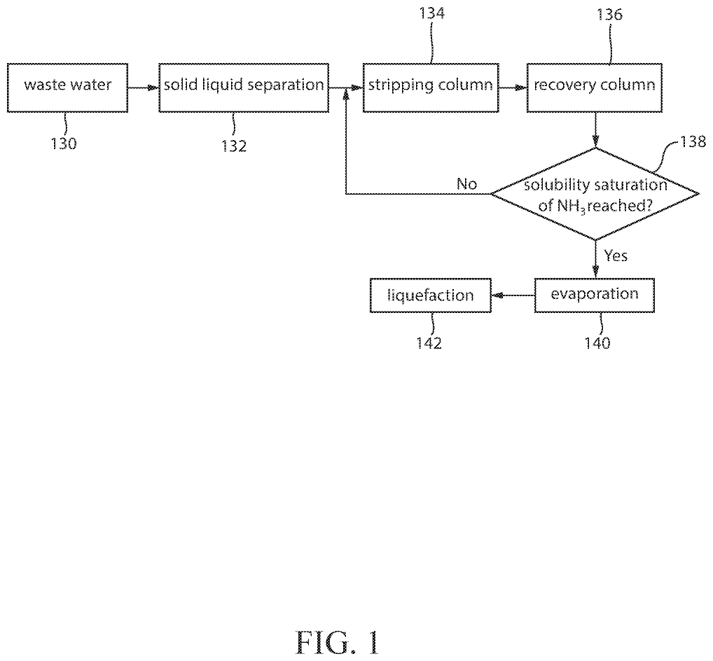

With reference to FIG. 1, in general terms, in step 130, wastewater 12 is introduced to the ammonia production system 10 of the present invention. In step 132, the wastewater is filtered by passing the wastewater through a solid-liquid separator. In step 134, the wastewater is pumped into a stripping column where the wastewater is aerated and a BrØnsted base is added to the solution. In step 136, the aerated wastewater is pumped into a recovery column where stripped ammonia gas is absorbed into a recovery solution with the addition of a BrØnsted acid, the BrØnsted acid being operative to react with the stripped ammonia gas to produce an ammonia product, the mixing of the stripped ammonia gas with the recovery solution defining a nitrogen solution or the ammonia product. In step 138, the saturation level of NH₃ is tested, if the level of NH₃ is below a predetermined level, the solution is returned to the stripping column. If the level of NH₃ is above a predetermined level, in step 140, the solution is pumped to an evaporator where an evaporation process takes place. Thereafter, in step 142, the evaporated ammonia product may be liquefied.

Turning now to FIGS. 1, 2, and 3, the steps of an exemplary process and the schematic system 10 for the recovery of NH₃ according to the methods and systems discussed herein are illustrated. NH₃ may be recovered from wastewater 12 and liquid bioammonia 62 may be subsequently produced.

Though these systems and methods can be applied to any wastewater 12 containing NH₄⁺, here flushed manure liquid is used as an example. The wastewater 12 may comprise solid components and liquid components, and if so, the wastewater 12 may be filtered to at least partially separate the liquid components from the solid components. Wastewater filtered in this fashion may be referred to as filtered wastewater. The filtered wastewater can be obtained from a wastewater mixture by a solid-liquid separator 14 which can include, but is not limited to, a screw separator, a screen separator, a centrifuge, a rotary separator, and combinations thereof. The filtered wastewater can be optionally stored in a lagoon or a sedimentation tank 42 before the liquid skimmed from the surface is pumped into a stripping column 24. Alternatively, the filtered wastewater may be directly sent to the stripping column 24. A centrifugal pump 16 may facilitate this process. The total suspended solid (TSS) level of the filtered wastewater from the solid-liquid separator 14 is preferably as low as possible, ideally no more than 10,000 mg/L.

Once the wastewater is pumped into the stripping column 24, whether it is filtered wastewater or just the original wastewater, air is sent by an air pump or an air blower 22 to the stripping column 24 through one or more air diffusers 28 equipped at the bottom of the stripping column 24 for aeration in the stripping step. The one or more air diffusers (i) may be, but they are not limited to, sintered stone diffusers, spargers, membrane diffusers, and combinations thereof.

Q_{G,s} of the air pump 22 should preferably be high.

$$( \frac{{Q}_{G , s}}{{V}_{s}} )$$

is ideally more than 1 t⁻¹, and the higher this value is, the faster the kinetics for the stripping becomes, according to Equation 10.

When the alkalinity of the wastewater fed to the stripping column 24 is high, as is the case for livestock manure such as dairy manure, the pH of the wastewater is normally high enough to transfer NH₄⁺ to NH₃ in the wastewater to some extent. At the standard condition, the shift to NH₃ occurs above pH=7. The high alkalinity is often caused by a high concentration of CaCO₃ or Ca(HCO₃)₂ in the wastewater.

However, the NH₃ stripping may cease once such chemicals are consumed by the following reaction of Equation 20:

2 NH₄⁺+CaCO₃+H₂O→2 NH₃+Ca(OH)₂+CO₂+2H⁺ (20)

The invented process may use a Brønsted base in a stored in a hopper 26 to strip NH₃ more completely from the flushed manure liquid by Equation 1. The Brønsted base may be mixed with the filtered wastewater inside the stripping column. When the Brønsted base is mixed with the filtered wastewater, the resulting solution may be referred to as a stripping mixture. The mole of the anion of the Brønsted base used may be stoichiometric to the mole of NH₄⁺ in the wastewater 12, which may be measured beforehand with conventional measurement methods such as a UV/vis spectrometer. Preferably, an excess amount of the Brønsted base, at least 10% or more stoichiometric to the mole of NH₄⁺ in the original wastewater 12, is desirably used to ensure the rapid mass-transfer kinetics and a more complete removal of NH₄⁺. The Brønsted base can also be added as needed, which may be determined via a pH sensor 20 measuring the pH of the stripping mixture.

The air diffuser(s) 28 for the stripping column 24 may preferably be configured such that they generates small air bubbles for desirable diffusions of bubbles inside the stripping column (g) to ensure that the NH₃ gas produced by Equation 1 is swiftly transported to the bubbles for stripping. The desirable diffusion can be made possible by small air bubbles with a slow rising velocity and a long retention time inside the stripping column 24. The orifice diameter for the air diffuser(s) 28 may be less than 50 μm, preferably less than 5 μm, to produce these small air bubbles.

The one or more air diffusers 28 that can be used for the stripping process include, but are not limited to, sintered stone diffusers, membrane diffusers, spargers, and combinations thereof; a higher surface area to orifice diameter ratio, which is often expressed as the surface area per length of a porous sparger, is another ideal property in these air diffusers. The preferred surface area per length of a porous diffuser is in the range of 0.5-3 inch²/inch.

The progress of the stripping process can be monitored with an NH₄⁺ sensor 18. Once NH₃ has been stripped to a desirable extent, the spent wastewater may be repurposed, such as by discharging it to a lagoon or a storage tank for spraying on croplands later. A new batch of wastewater may then be filtered and pumped into the stripping column and this cycle could be repeated until the product in the recovery column 32 is saturated.

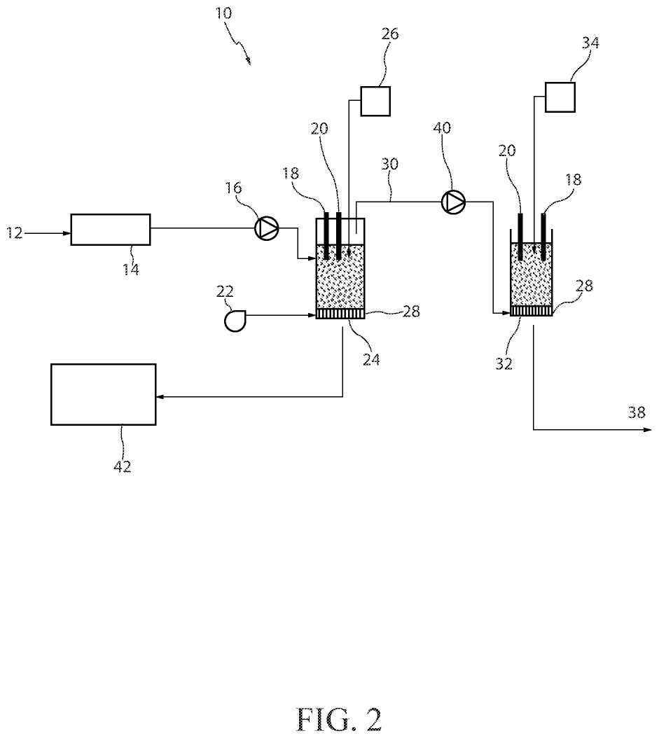

The stripped NH₃ gas 30, along with the N₂, O₂, and often CO₂ gases, all of which may be generated by aeration in the stripping column 24, may be pumped by a pneumatic pump 40 into the recovery column 32. The piping that may transport these stripped gasses to the recovery column may incorporate a heat exchanger operative to raise the temperature of the stripped NH₃ gas (although this is not depicted in FIG. 2). This may increase the kinetic energy of the stripped NH₃ gas; NH₃ gas molecules with a higher kinetic energy has more collision frequency against the bubble walls, hence increasing the concentration at the interface with the recovery solution, raising the mass transfer to the recovery solution in the recovery column. The stripped NH₃ gas may be bubbled through air diffusers 28 equipped at the bottom of the recovery column 32. The recovery column 32 could be at least partially filled by an acidic recovery solution including water which may be operative to absorb and recover the stripped ammonia gas. The pneumatic pump 40 pumping the stripped ammonia gas can increase the flowrate, Q_{G,r}, to the recovery column 32, which raises the mass-transfer kinetic rate of the gas-liquid NH₃ transfer, according to Equation 18. Recovery solution 34 containing a Brønsted acid may be supplied as needed, which can be determined by the readings of a pH sensor (e).

Q_{G,r} may preferably be such that

$$( \frac{{Q}_{G , r}}{{V}_{r}} )$$

is more than 1 t⁻¹, and the higher the number is, the faster the kinetics for the stripping becomes, according to Equation 18.

The one or more air diffusers 28 in the recovery column 32 may be configured so as to generate small air bubbles for desirable diffusions of bubbles inside the recovery column 32, ensuring that the air bubbles containing the NH₃ inside have sufficient contact with the acid 34 in the recovery column 32. The desirable diffusion can be made possible by a slow rising velocity and a long retention time of the air bubbles inside the recovery column 32. The one or more air diffusers 28 for bubbling the NH₃ gas into the acidic aqueous solution may have small pores operative to generate small bubbles which have a long retention time to ensure the diffusion of air bubbles throughout the recovery column 32. The orifice diameter for the one or more air diffusers 28 may be less than 50 μm, preferably less than 5 μm to achieve this result.

The one or more air diffusers 28 for the recovery process may include, but are not limited to, sintered stone diffusers, membrane diffusers, spargers, and combinations thereof. Having a higher surface area to orifice diameter ratio, which is often expressed as the surface area per length of a porous sparger, is an ideal property in these air diffusers. The preferred surface area per length of a porous diffuser may be in the range of 0.5-3 inch²/inch.

Although not depicted, a mesh screen can be used in the stripping column 24 or recovery column 32 to break up the rising air bubbles from the one or more air diffusers 28. It is known that as the air bubbles rise through a liquid column, their sizes grow. A mesh screen, otherwise known as bubble breakers, can reduce the bubble size (Kalbfleisch, A. “The Effect of Mesh-Type Bubble Breakers On Two-Phase Vertical Co-Flow,” Electronic Thesis and Dissertation Repository, 3946 (2016). https://ir.lib.uwo.ca/etd/3946). The size of the mesh screen can be less than 1 mm. The screen can help maintain the original bubble size through the column.

The aerated gases 30 coming from the stripping column may include not only NH₃, but N₂, O₂, and possibly CO₂ as a result of the aeration process in the stripping column 24. These latter gases can interfere with the stripped NH₃'s absorption into the recovery solution in the recovery column. The acid also may ensure the absorption of the NH₃ gas through the acid-base reaction, as shown by Equation (2), by a sufficient concentration of protons at the interface between the air bubbles and the liquid which facilitates the transfer of the NH₃ gas into the recovery solution.

The mass of the acid supplied to the recovery column 32 can be determined by the solubility of the acid in water. For example, strong acids such as sulfuric acid and nitric acid are completely miscible in water. Then, the mass of the acid is determined by the maximum solubility of the product in Equation 2, an ammonium salt. The NH₃ gas may continually be sent to the recovery column 32 by replacing the wastewater in the stripping column 24 until the product concentration reaches its maximum in the recovery column 32. For example, the solubility of (NH₄)₂SO₄, the product when the acid is sulfuric acid, is 744 g L⁻¹ in water at room temperature. Accordingly, the concentration of NH₄⁺ at the maximum solubility is 19%. The use of reaction in Equation 2 is to facilitate the absorption of NH₃ into the water. The progress of the recovery process may be measured via an NH₄⁺ sensor 18.

Once ammonium acid reaches the maximum solubility in the recovery column 32, the air bubbling in the stripping column may be stopped. Then the pump 40 should also be stopped. The resulting solution, which can be referred to as a saturated solution 38, can discharged from the column, and stored under ambient conditions. Depending on the species in the recovery solution, this saturated solution can differ in chemical composition and species produced via reactions in the recovery column 32. The product can be a highly concentrated nitrogen solution that can be used as is, such as a renewable nitrogen fertilizer.

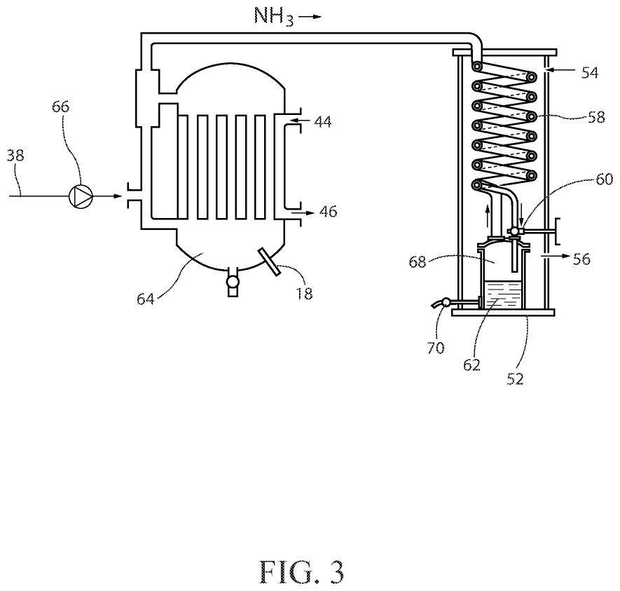

Alternatively, the saturated solution 38 can be pumped into an evaporator 64 via a pump 66, as is illustrated in FIG. 3. Steam can be circulated through a steam inlet 44 and a steam outlet 46 inside the evaporator 64 to bring the temperature inside the evaporator to around 80° C. or until the saturated solution starts to boil. Alternative heating elements may be utilized as well, including heating coils. This temperature may cause NH₃ in the saturated solution 38 to start to transfer from the liquid phase to the gas phase. This step may be continued until an NH₄⁺ sensor 18 shows a desired small value of NH₄⁺ concentration inside the evaporator 64.

The NH₃ gas evaporated in the evaporator 64 may then be sent to the liquefaction device 52. A pipe connecting the evaporator 64 and the liquefaction device 52 may be attached to a coiled pipe 58, preferably made from stainless-steel, inside the liquefaction device 52 whereby the NH₃ gas may be put into thermal contact with a coolant circulating inside the liquefaction device through a coolant inlet 54 and coolant outlet 56. As the NH₃ gas travels through the coiled pipe 58, the NH₃ gas molecules can undergo condensation if the temperature is below −33.3° C., the boiling temperature of NH₃ at one atmospheric pressure. The condensed bioammonia liquid 62 may be collected in the liquid collector 68 and discharged from the liquid outlet 70. The other gases introduced to the liquefaction device 52, which may include N₂ and O₂, can be released from the liquefaction device 52 via a release valve 60. The air gases, along with CO₂ gas, can cause substantial interference with the liquefaction of the NH₃ gas, as will be demonstrated later in this disclosure, and may thus be desirously removed in this fashion.

Once those extraneous gasses are removed from the liquefaction device 52, the gas being sent from the evaporator 64 may mostly be the NH₃ gas. Hence, there is less interference of the NH₃ liquefaction arising from other gases. The melting point of NH₃ is −77.7° C. at one atmospheric pressure. Hence, the temperature inside the liquefaction device may preferably stay between −70° C. and −40° C. at atmospheric pressure to prevent freezing. Accordingly, the coolant for the liquefaction device should stay as a liquid at temperatures between −70° C. and −40° C. The temperature range can thus preferably be between −60° C. and −50° C. The coolants that can be used include, but are not limited to, iso-propanol, acetone, 1- or 2-butanol, 2-butanone, ethanol, diethyl ether, heptane, n-hexane, pentane, 1-propanol, tetrahydrofuran, and triethyl amine. The liquefaction of the NH₃ gas has been industrially performed for decades and the cryogenic technology associated with the liquefaction is well established. NH₃ gasification can occur at −33.3° C. If the upper temperature inside the liquefaction device is close to −33° C., there is a risk of losing some of the recovered NH₃. Further, temperatures below 70° C. is too close to the melting point of CO₂ under atmospheric pressure, −78.46° C. Hence, there is a risk of contaminating liquid NH₃ with some CO₂ solid at these temperature ranges. Accordingly, the temperature range for the liquefaction of NH₃ should ideally be set between −70° C. and −40° C., preferably between −60° C. and −50° C.

In another embodiment, the liquefaction of evaporated NH₃ gas described above can be applied to any N solutions recovered from livestock manure or anaerobic digestate liquid by any means including conventional NH₃ stripping/scrubbing processes or membrane recovery processes.

In another embodiment, the liquefaction of evaporated NH₃ gas described above can be carried out by applying a pressure. For example, the NH₃ gas can be liquefied at a pressure of 7.5 bar at 20° C.

In yet another embodiment, the concentration of the Brønsted base, the type of the base, the orifice diameter of the one or more air diffusers 28, the number of air diffusers in the column, the ratio of the column diameter to the height, the surface area per length of the one or more air diffusers, and the ratio of Q_{G,s} to V_{L,s} for the stripping process are optimized such that the mass transfer rate per unit volume, σₛ, in the stripping process is at least 3 min⁻¹.

In yet another embodiment, the concentration of the Brønsted acid, the type of the acid, the orifice diameter of the one or more air diffusers 28, the number of air diffusers in the column, the ratio of the column diameter to the height, the surface area per length of the one or more air diffusers, and the ratio of Q_{G,r} to V_{L,r} for the recovery process are optimized such that the mass transfer rate per unit volume, σ, in the recovery process should be at least 0.006 min⁻¹.

In yet another embodiment, the concentration of the Brønsted base, the type of the base, the orifice diameter of the one or more air diffusers 28, the number of air diffusers in the column, the ratio of the column diameter to the height, the surface area per length of the diffuser, and the ratio of Q_{G,s} to V_{L,s} for the stripping process are optimized such that K_{L,s}·aₛ is larger than

$$\frac{{Q}_{G , s} {H}_{s}}{{V}_{L , s}}$$

in the mass transfer rate per unit volume for the stripping process.

In yet another embodiment, the concentration of the Brønsted acid, the type of the acid, the orifice diameter of the air diffuser 28, the number of diffusers in the column, the ratio of the column diameter to the height, the surface area per length of the diffuser, and the ratio of Q_{G,r} to V_{L,r} for the recovery process are optimized such that K_{L,rs}·aᵣ is larger than

$$\frac{{Q}_{G , r} {H}_{r}}{{V}_{L , r}}$$

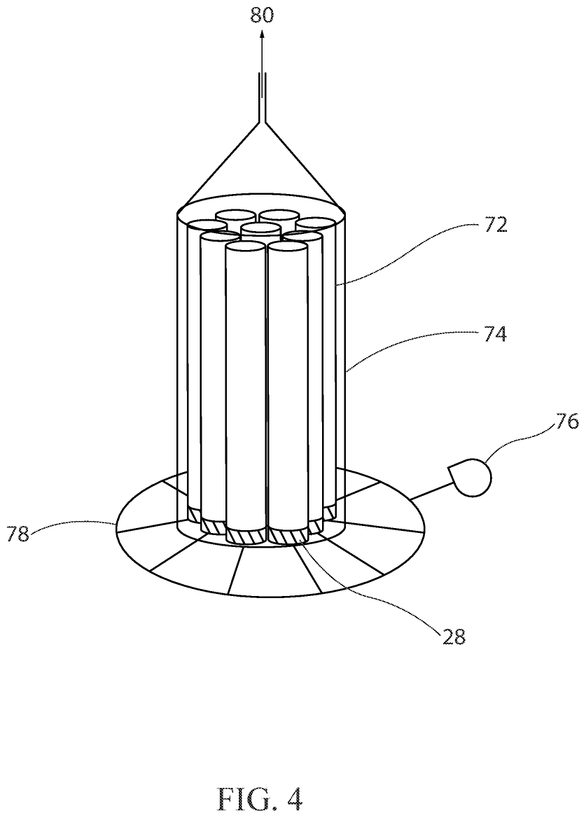

in the mass transfer rate per unit volume for the absorption process. Looking now to FIG. 4, an illustration of an exemplary stripping column is shown. A stripping column may comprise a number of sub columns 72 (1″-2″ in diameter) which may be tightly packed together inside a stripping column housing 74. Equation 10 shows that a smaller sub column 72 diameter gives a higher mass-transfer rate for a given number of orifices across a column by increasing the flux of air bubbles, hence raising aₛ. This design shown in FIG. 4 allows a high mass-transfer rate at a full scale where a high flowrate of wastewater needs to be treated. The stripping may be performed in each sub stripping column 72; each sub column 72 may be equipped with an air diffuser 28 at the bottom of each sub column 72. The air diffusers may receive the air from a pump 76 connected to the stripping column housing 74 via a pipe 78. Saturated solution from the sub-columns exits the column housing 74 at a common outlet 80. As will be shown under EXAMPLE 3, the stripping rate may rise when the diameter of the column is reduced.

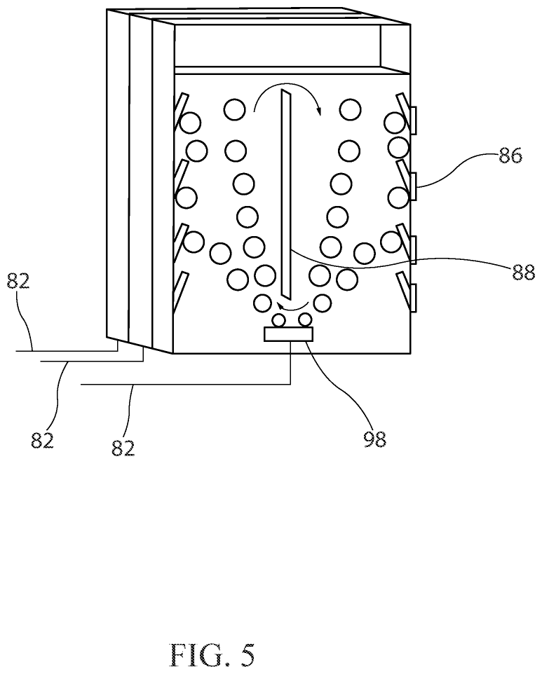

Turning now to FIG. 5, an illustration of an exemplary recovery column 32 is shown. This recovery column may receive stripped ammonia gas 82 through a sparger diffuser 98. A partition plate 88 may be at the center of the column to promote liquid circulation inside the recovery column and to distribute air bubbles evenly through the recovery column. A number of slant baffles 86 which may be present on the column walls may be operative to slow down the rising velocity of air bubbles from the sparger diffuser 98. These features may thus enhance the capability of the recovery solution to recover the stripped ammonia gas 82 received by the recovery column.

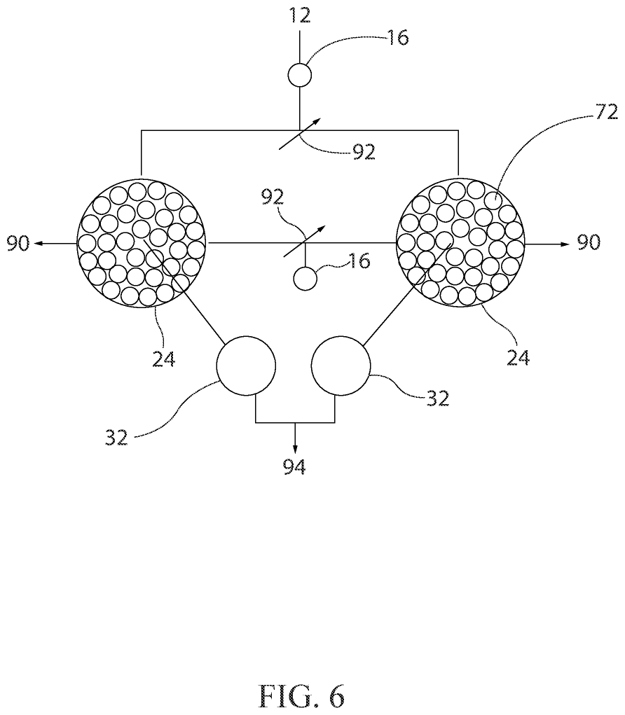

Bringing our attention now to FIG. 6, another embodiment comprising a pair of stripping columns 24 and a pair of recovery columns 32 is shown. This embodiment may allow for an operation to be carried out in a semi-continuous fashion by using pairs of coupled stripping columns and recovery columns. When one of the paired stripping columns 24 is used for stripping, the other stripping column 24 may discharge the spent wastewater through a first discharge 90 before being washed for subsequent stripping with a new batch of wastewater. This switch between the two stripping columns can be carried out by a valve 92 that can change the direction of the flow of wastewater 12 being fed from a centrifugal pump 16). Likewise, when one of the pair of the recovery columns 32 is used to absorb NH₃, the other recovery column may discharge the saturated solution through a second discharge 94 and be washed. Either the striping columns or the recovery columns or both may comprise a plurality of sub-columns 72. This design allows the system to be operated continuously without the need for a holding tank.

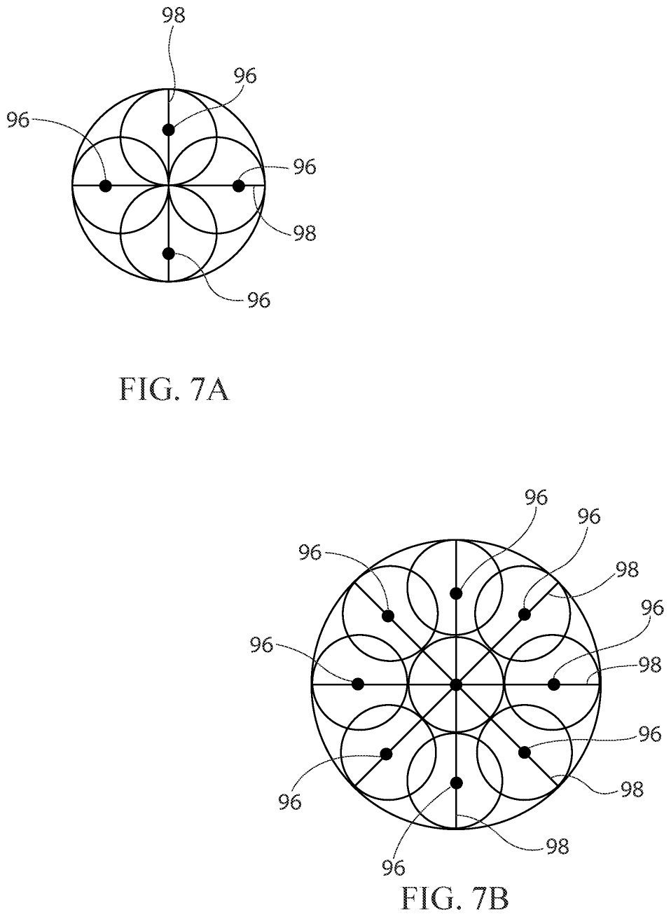

Looking now to FIGS. 7a and 7b, cross sectional views of two embodiments of a column showcasing their air diffusers 28 are shown. These embodiments can be used in the recovery column 32, the stripping column 24, or both in a certain system. These embodiments present how the number of air diffusers used in a column of a given size can be arrived at. The dots (●) and the straight lines (-) across the column bottoms represent sintered stone air diffusers 96 and sparger pipe diffusers 98, respectively. The diameter of the circles inside the column are all each 1″. These circles are not columns, but imaginary circles for the discussion. In certain embodiments, stone air diffusers (●) 96 can be used, and the number of these air diffusers (N_{dif}) for both columns, the stripping and the recovery columns, can be determined by the following equation:

N_{dif}=n² (21)

where n is an integer ranging from 1 and above representing the diameter of a given column in inches. If the diameter is a real number, the rounded number can be used. FIG. 7A illustrates the relationship between N_{diff} and n for a 2″-diameter column and FIG. 7B for a 3″-diameter column. Accordingly, in FIG. 7A there are four sintered stone air diffusers 96 while in FIG. 7B there are nine sintered stone air diffusers 96.

In other embodiments, just sparger-pipe diffusers (-) 98 may be used for the aeration of both columns, and the number of these diffusers (N_{dif}) per stripping column can be equal to the number of pipes as follows:

N_{dif}=n when n is an even number (22)

N_{dif}=n+1 when n is an odd number (23)

In FIG. 7a, it can be seen that there are two sparger-pipe diffusers 98, while in FIG. 7B there are four sparger-pipe diffusers 98. The number of air pumps which pump the air/stripped ammonia gas to these air diffusers may also correlate to the geometry of the column they are associated with. As an example, the number of air pumps (Nₚᵤₘₚ) per column may be chosen by the following equations:

Nₚᵤₘₚ=n (24)

when n is an even number and

Nₚᵤₘₚ=n+1 when n is an odd number (25)

where n is the same as in Equation 21.

Once bioammonia is obtained by the process described above, another step can be performed in which it is mixed with the CO₂ gas under high pressures (˜110 atm) at temperatures ˜60° C. to produce urea by the following reactions of Equations 26 and 27:

2NH₃+CO₂ [symbol] [H₂N—CO₂][NH₄] (26)

[H₂N—CO₂][NH₄] [symbol] (NH₂)₂CO+H₂O (27)

The CO₂ gas used in Equation 26 can includes, but it is not limited to, the CO₂ gas generated by an anaerobic digestor using livestock manure and/or organic wastes in general as the feed, the CO₂ gas generated by coal-fired power plants, any CO₂-generating industrial plants, the CO₂ gas produced as a by-product in the stripping column when alkali carbonate or alkali bicarbonate is used as the Brønsted base. For every ton of urea produced by this process, not only is 0.73 MT of CO₂ consumed by Equation 21, but also 1.6 MT of CO₂ is reduced by using bioammonia produced by these methods and systems in place of synthetic NH₃ which produces 1.6 MT of CO₂ for every MT of synthetic NH₃ produced. [“Ammonia: Zero-Carbon Fertilizer, Fuel, and Energy Store,” The Royal Society, February, 2020.] Hence, the total of 2.33 MT of CO₂ emissions per 1 MT of urea can be eliminated by the urea synthesis Equation 27.

The difference from other NH₃ recovery processes found in the literature may include the use of the stoichiometric chemical reactions or more than stoichiometric chemical reactions shown in Equations 1 and 2 to facilitate the NH₃ stripping and absorption into the water and the optimization of the mass-transfer reaction kinetics of the NH₃ stripping and absorption.

In another embodiment, when the alkalinity of wastewater is high enough, aeration of such wastewater can strip not only NH₃ gas, but CO₂ gas as well without addition of any base. When the stripped gases are absorbed in water, ammonium bicarbonate may be produced without any acid, according to the following equation:

NH₃+CO₂+H₂O→NH₄HCO₃ (28)

The kinetic model described in this invention can be applied to facilitate the liquid-to-gas mass transfers of the NH₃ and CO₂ gases and the gas-to-liquid mass transfers of the gases to water.

### EXAMPLE 1

### Effects of Aeration on pH of Stripping Mixture

Aeration may be an important component in these processes and could be a key factor in driving the NH₃ stripping in the stripping column. By comparing the results of experiments according to the systems and processes disclosed herein with a prior art method, specifically U.S. Pat. No. 11,364,463, the surprising improvement that the former may yield will be more clearly shown. In one of the embodiments in U.S. Pat. No. 11,364,463, it states that the aeration of digestate liquid generates CO₂ gas when the alkalinity of the liquid is high, according to the following formula in Equation 28:

HCO₃⁻+air→CO₂+OH⁻ (28)

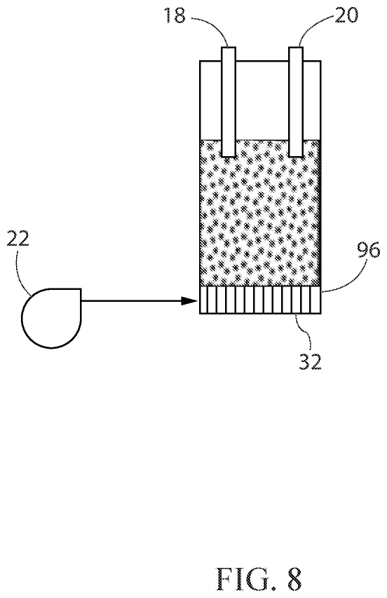

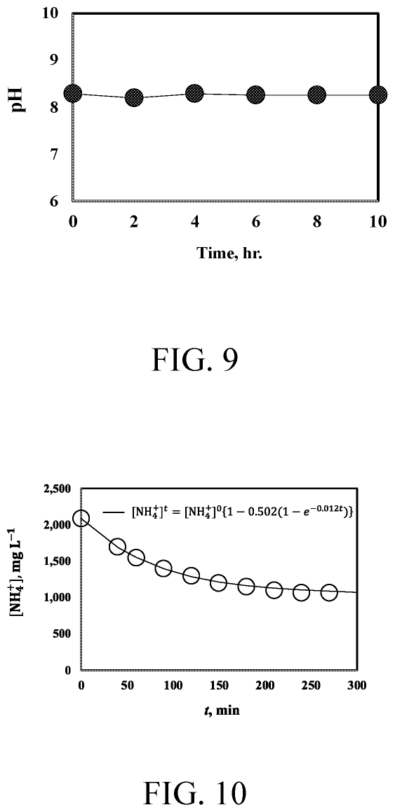

The patent further asserts that the produced OH⁻ raises pH in the liquid, shifting the equilibrium of NH₄³⁰ to NH₃. This is important to note because Equation 28 shows how NH₃ may be stripped from the wastewater. We shall examine whether Equation 28 holds. Looking now to FIGS. 8, 9, and 10, the experiment setup of a prior art ammonia gas stripping method and the results of this experiment are illustrated. A 1 mM bicarbonate solution was prepared by mixing Ca(HCO₃)₂ in water to simulate a high alkalinity solution. The pH value was 8.3. This solution was introduced to a stripping column 32 with a height of 40″ and a diameter of 4″. Sintered stone diffusers 96 with a 2 μm orifice diameter were placed at the bottom of the stripping column 32 which were connected through a pipe to an air blower 22. The air flowrate was 30 L min⁻¹. A pH meter 20 was inserted into the solution to monitor the pH, as well as a NH₄⁺18 sensor to measure the NH₄⁺ concentration. The aeration continued for 10 hrs. FIG. 9 plots the pH of the solution as a function of time. According to Equation 28, pH should increase by the aeration process. Yet, the pH of the solution stayed flat throughout the aeration. This is due to the following equilibrium shown in Equation 29:

HCO₃⇄CO₂+OH⁻ (29)

This equilibrium may be determined primarily by pH and temperature to a certain extent. Once pH is determined by the concentration of the bicarbonate, pH does not change, regardless of aeration, supported by our observation. The result demonstrates that aeration alone does not raise pH of the alkaline solution.

### EXAMPLE 2

### Prior Art Ammonia Gas Stripping

Next, the NH₃ stripping process was conducted, using ADL separated by a solid-liquid separator as the filtered wastewater. The sample was taken from a dairy farm with 5,000 cows in the Central Valley, California. The ADL had the NH₄⁺ and NO₃⁻ concentrations of 2,086 mg L⁻¹, and 5.3 mg L⁻¹, respectively, the total nitrogen content of 2,300 mg L⁻¹, the alkalinity of 8,800 mg L⁻¹, the total solid and TSS of 9,300 mg L⁻¹ and 4,000 mg L⁻¹, respectively, phosphorus of 130 mg L⁻¹, and pH of 8.2. The same experimental setup as EXAMPLE 1 was used for this experiment.

First, a similar condition described in U.S. Pat. No. 11,364,463 was used for the stripping without applying the acid-base reaction Equation 1: pH in the original ADL was 9 in U.S. Pat. No. 11,364,463. Hence, the pH of the ADL was adjusted by adding NaOH to 9; however, no additional NaOH was supplied to maintain the same pH during the aeration. Though the temperature was set to be at 35° C. in U.S. Pat. No. 11,364,463, the temperature of ADL was ambient for all the examples presented in all the examples. The air flowrate was 30 L min⁻¹, and the volume of the digestate liquid was 2 L. For aeration, sintered stone air diffusers 96 with an orifice diameter of 50 μm were used. The number of air diffusers was eight. The dimension of the stripping column was 40″ high and 4″ wide. The same volume of the digestate liquid, diffusers, and air flow were used for all the examples.

FIG. 10 shows the decay of [NH₄⁺] as a function of time during aeration in the stripping column under the condition described above. Inside the figure, the equation corresponding to Equation 12 is included. ηₛ was determined by Equation 3, while σₛ was obtained from the slope of the line by plotting the left side of Equation 9 against t. The values of R² for the linear regressions in determining ηₛ and σₛ were 0.996 and 0.997, respectively. The experimental data are well reproduced by the equation, displayed by the solid line, which suggests that the stripping process follows Equation 12. The standard deviations of calculated [NH₄⁺] by the equations shown by the solid and the broken lines from the experimental data are 20.0 mg L⁻¹ and 19.8 mg L⁻¹, respectively. The removal yield was 50% which is close to what is described in U.S. Pat. No. 11,364,463. Only half the original NH₃ was removed under this condition. As NH₄⁺ donates its proton to OH⁻ to transform itself to NH₃, OH⁻ is consumed. As less OH⁻ is available for the proton donation, NH₄⁺ has no choice, but to stay as is without transforming itself to NH₃. Once OH⁻ is consumed, the following reaction stops, and the equilibrium is reached via Equation 30:

NH₄⁺+OH⁻→>NH₃+H₂O (30)

That is when [NH₄⁺] became nearly plateau after 250 min. This process wastes another half of NH₃ potentially available for the recovery. ηₛ, pₛ, and σₛ were 50.2%, 254.2 mg L⁻¹ h⁻¹, and 0.012 t⁻¹, respectively.

### EXAMPLE 3

### Effects of Adjusting the Diameter of the Stripping Column

This example examined the effect of one of the operating parameters, the stripping column diameter, on ηₛ and σₛ. Two columns were tested: the diameters of 4″ and 1″. The height was the same for both columns: 40″. Everything else was the same as EXAMPLE 2 except that pH of ADL was adjusted to be 12 by adding NaOH before aeration, but no additional NaOH was supplied during aeration. The same experimental setup as EXAMPLE 1 was used for this experiment.

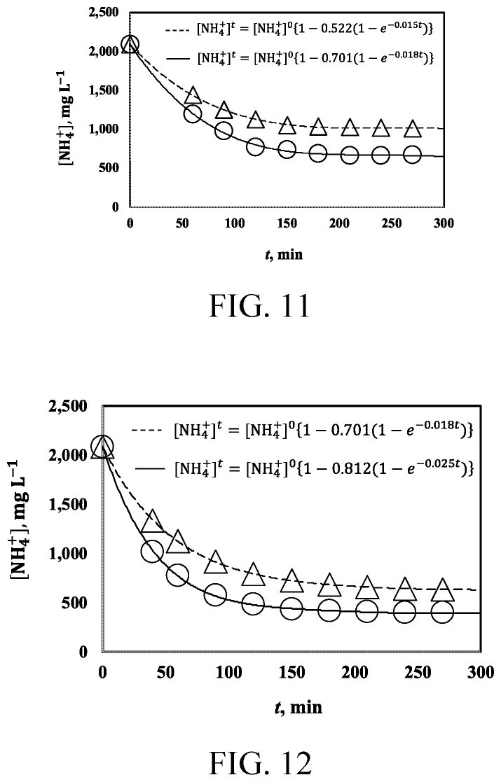

Turning now to FIG. 11, the experimental results of the decay of [NH₄⁺] as a function of time in the stripping columns with a 4″ diameter (Δ) and a 1″ diameter (◯) during aeration are displayed. The equations corresponding to Equation 12 are included for each plot. ηₛ and σₛ were determined as described above in EXAMPLE 2. The values of R² for the linear regressions in determining σₛ were 0.998 and 0.995 for the solid and broken lines, respectively. Both sets of experimental data are well reproduced by the equations, the broken line for the 4″ diameter column and the solid line for the 1″ diameter column. The standard deviations of calculated [NH₄⁺] by the equations shown by the solid and the broken lines from the experimental data are 19.9 mg L⁻¹ and 19.8 mg L⁻¹, respectively. The agreements suggest that both stripping processes follow Equation 12. The column with a 1″ diameter had a 34% more removal yield and a 9.6% higher removal rate than the column with a 4″ diameter. This may be due to more air bubbles generated across the column per inch² of the smaller diameter column, giving rise to a higher interface area per volume for the mass transfer. These results demonstrate the validity of our mass-transfer kinetics model. ηₛ, ρₛ, and σₛfor the column with a 1″ diameter were 70.1%, 291.2 mg L⁻¹ h^{'1}, and 0.018 r¹, respectively.

### EXAMPLE 4

### Effects of Adjusting the Orifice Diameter of the Stripping Column

This example examined the effect of another operating parameter, namely the orifice diameter of the air diffuser, on ηₛ and σₛ. Two orifice diameters were tested: diameters of 2 μm and 50 μm. Everything else was the same as EXAMPLE 3. The column diameter was 1″. The same setup as EXAMPLE 1 was used for this experiment.

Looking now to FIG. 12, the results of the decays of [NH₄⁺] as a function of time, using the air diffuser with a 50-μm diameter orifice (Δ) and a 2-μm diameter orifice (◯) during aeration are shown. The equations corresponding to Equation 13 are included for each plot. ηₛ and σₛ were determined as described above in EXAMPLE 2. The values of R² for the linear regressions in determining as were 0.995 and 0.997 for the solid and broken lines, respectively. The equations, the broken line for the diffuser with the 50-μm orifice diameter and the solid line for the diffuser with the 2-μm orifice diameter, well reproduced both sets of the experimental data. The standard deviations of calculated [NH₄⁺] by the equations shown by the solid and the broken lines from the experimental data are 19.9 mg L⁻¹ and 20.0 mg L⁻¹, respectively. The agreements suggest that both stripping processes follow Equation 12. The diffuser with a 2-μm diameter orifice produced a 16.2% more removal yield and a 15.8%% higher removal rate than the diffuser with a 50-μm diameter. This could be due to more surface area of the air bubbles generated by the diffuser with a 2-μm diameter orifice, giving rise to a higher interface area per volume for the mass transfer. The results demonstrate the validity of our previously derived mass-transfer kinetics model. ηₛ, ρₛ, and σₛ for the diffuser with the 2-μm orifice diameter were 81.2%, 480.4 mg L⁻¹ h⁻¹, and 0.025 t⁻¹, respectively.

### EXAMPLE 5

### Comparison Between Usage and Omission of a BrØnsted Acid/Base

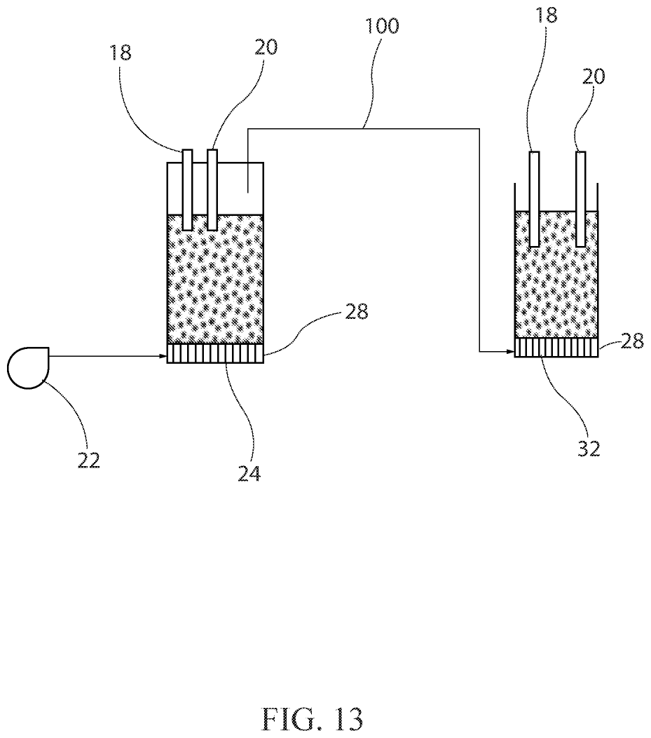

Looking now to FIG. 13, the experimental setup of an ammonia gas stripping and recovery process according to the methods and systems disclosed herein is illustrated. This example examined the effects of the acid-base reactions, Equations 1 and 2, on η_{s/r} and σ_{s/r}. Ca(OH)₂ and H₂SO₄ were used as the Brønsted base and acid for Equations 1 and 2, respectively. 12 g of Ca(OH)₂ was added to 2 L of ADL in the stripping column 24 to form the stripping mixture, while 12 g of 100% H₂SO₄ was mixed with 2 L of distilled water in the recovery column 32 to form the recovery solution. The mole of the former was 30% more than what is stoichiometric to the mole of NH₄⁺ in the original ADL. On the other hand, the mole of the latter chemical was stoichiometric to the mole of NH₄⁺ in the original ADL, assuming a 100% removal yield. The condition was the same as EXAMPLE 3, and sintered stone diffusers 96 with an orifice diameter of 2 μm was used. pH in the stripping column 24 was 12 in the beginning of the experiment and gradually declined to 11 at the end, while pH in the recovery column 32 started at a value of 1.55 and ended with a pH of 5.5. In another experiment for comparison, the pH of ADL in the stripping column 24 was adjusted to be 12 by adding NaOH, but no further NaOH was added during the aeration, which is the same as EXAMPLE 3. For the recovery column 32, the pH was adjusted to be 5 by adding HCl. This condition in the recovery column is similar to U.S. Pat. No. 11,364,463. The stripped NH₃ gas 82 was sent from the stripping column 24 to the recovery column 32 via piping 100 along with other gases including N₂, O₂, and CO₂ and bubbled at the bottom of the recovery column 32 through the sintered stone diffusers 96. The pH and the NH₄⁺ concentrations in both the stripping 24 and the recovery column 32 were monitored during the aeration via pH meters 20 and NH₄⁺ sensors 18.

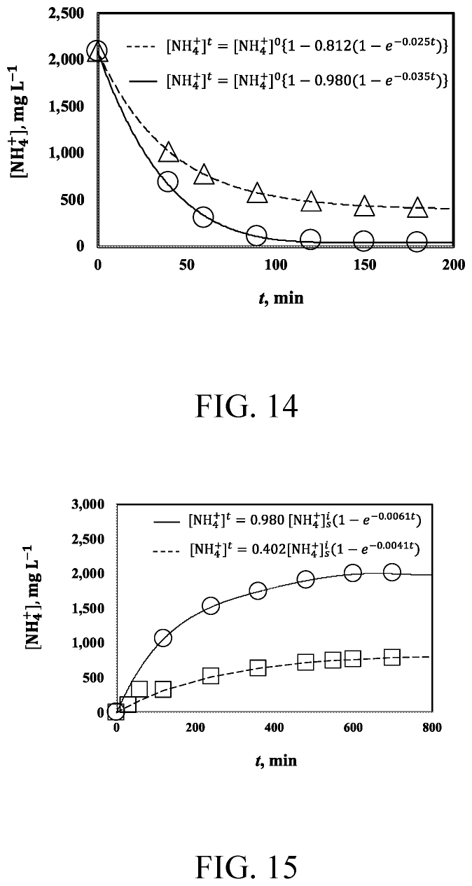

Turning now to FIG. 14, the experimental results of the decays of [NH₄⁺] as a function of time in the stripping column, using the base according to Equation 1 (◯) and not using any base, but with the ADL having the initial pH of 12 (Δ), are shown. The equations corresponding to Equation 12 are included for each plot. ηₛ and σₛ were determined as described above in EXAMPLE 2. The values of R² for the linear regressions in determining as were 0.997 and 0.998 for the solid and broken lines, respectively. The equations, the broken line for the stripping without the base and the solid line for the stripping with the base, well reproduce both sets of experimental data. The standard deviations of calculated [NH₄⁺] by the equations shown by the solid and the broken lines from the experimental data are 19.1 mg L⁻¹ and 21.0 mg L⁻¹, respectively. The agreements suggest that both stripping processes follow Equation 12. ηₛ and σₛ were determined as described above in EXAMPLE 3. The difference between with and without the use of the base is clear. Applying Equation 1 not only accelerated the mass transfer of NH₃ from liquid to gas, but also removed NH₃ nearly completely. The use of acid-base reaction kinetics produced a 21% more removal yield and a 165% higher removal rate than the stripping without it. This may be due to the promotion of the removal of NH₃ through the acid-base reaction which is fast and complete. ηₛ, ρₛ, and σₛ with the use of Equation 1 were 98%, 1274.5 mg L⁻¹ h⁻¹, and 0.034 min⁻¹, respectively. Our experiments conclude that the effect of the acid-base reaction has the largest impact on ηₛ and σₛ.

Focusing now on FIG. 15, the experimental results of the growth of [NH₄⁺] as a function of time in the recovery column, using H₂SO₄ according to eq 2 (◯) and not using any chemical, but with an initial pH of 5 (Δ) set by adding HCl to distilled water, are displayed. The equations corresponding to Equation 17 are included for each plot. ηᵣ and σᵣ were determined as described above in EXAMPLE 3. The values of R² for the linear regressions in determining σᵣ were 0.998 and 0.997 for the solid and broken lines, respectively. The equations, the broken line for the absorption without H₂SO₄ and the solid line for the absorption with H₂SO₄, well reproduce both sets of the experimental data. The standard deviations of calculated [NH₄⁺] by the equations shown by the solid and the broken lines from the experimental data are 29.7 mg L⁻¹ and 6.8 mg L⁻¹, respectively. The agreements suggest that both absorption processes follow Equation 17. The difference between with and without the use of Equation 2 is clear. Applying Equation 2 not only accelerated the mass transfer of NH₃ from gas to liquid, but also absorbed the stripped NH₃ gas into the acidic recovery solution nearly completely. Using the acid-base reaction kinetics produced a 145% more recovery yield and a 199% higher recovery rate than the stripping without it. This could be due to the accelerated NH₃ absorption through the acid-base reaction which is fast and complete. ηᵣ and ρᵣ with the use of eq 2 are 98% and 200.01 mg L⁻¹ h⁻¹, respectively, significantly higher than those without H₂SO₄, 40% and 66.89 mg L⁻¹ h^{-1 ,} respectively. When Equation 2 was not used, once the original acid concentration was consumed, the mass transfer rate significantly dropped, with little transfer of the NH₃ gas to the solution. σᵣ with the acid-base reaction was 0.0061 min⁻¹.

Table 1 summarizes the removal yields/rates and the recovery yield/rate for EXAMPLE 2 -5. The results demonstrate that the use of acid-base reactions in the NH₃ stripping/absorption significantly increases the removal yield/rate and the recovery yield/rate which translates to a high NH₃ recovery and a high productivity of the NH₃ stripping, which can lead to a low production cost.

TABLE 1
The Removal Yield and Rate and Recovery
Yield and Rate under Different Conditions^{a}

| | EXAMPLE 2 | EXAMPLE 3 | | EXAMPLE 4 | | EXAMPLE 5 | |
|---|---|---|---|---|---|---|---|
| pH | 9 | 12 | | 12 | | 12 | |
| orifice | 50 | 50 | | 2 | 50 | 2 | |
| diameter (μm) | | | | | | | |
| column diameter (“) | 4 | 1 | 4 | 1 | | 1 | |
| acid-base reaction | no | no | no | no | no | yes | No |
| ηₛ (%) | 50.2 | 70.1 | 52.2 | 81.2 | 70.1 | 98.0 | 81.2 |
| ρₛ (mg/L/h) | 254.2 | 291.2 | 265.8 | 480.4 | 291.2 | 1,274.5 | 480.4 |
| ηᵣ (%) | | | | | | 98 | 40 |
| ρᵣ (mg/L/h) | | | | | | 200.1 | 66.9 |

ªTemperature was ambient.

### EXAMPLE 6

### Continuous Stripping/Recovery of the BrØnsted Acid/Base Method

In this example, the stripping process was continued under the same condition as that for EXAMPLE 5 by replacing ADL in the stripping column once the stripping was completed, while keeping the same solution in the recovery column by absorbing NH₃ continuously into the acidic recovery solution. This cycle was repeated until the solubility of (NH₄)₂SO₄ in water reached its limit. The solubility of (NH₄)₂SO₄ in water is 744 g L⁻¹, corresponding to 202.9 g L⁻¹ of NH₄⁺. The UV-vis spectroscopy measurement of the final solution indicated an NH₄⁺ concentration of 19.7%.

Table 2 compares the results of this EXAMPLE 6 with others published in the literature. After an exhaustive literature search, no publication reporting ρₛ higher than 400 mg L⁻¹ h⁻¹ was found. On sharp contrast, the experiments according to the methods and systems discussed herein produced a three-fold higher ρₛ. This may have arisen due to a rigorous application of the acid-base reaction to facilitate the mass-transfer reaction kinetics of NH₃ from liquid to gas.

TABLE 2
Comparison of Results by This Invention Against Others in Literature.

| | | | [NH₄⁺]ₛ⁰ | η_{s/r} | ρ_{s/r} | | |
|---|---|---|---|---|---|---|---|
| | pH | T, º C. | mg/L | % | mg/L/h | Comments | Ref. |
| tower stripping | 8.5 | 70 | 1,100 | 63 | 115 | air flowrate = 117 L h⁻¹ | ^{a} |
| with circulation | 7.66 | 50 | 1,298 | 95 | 329 | air flowrate = 2.7 L h⁻¹ | ^{b} |
| absorption | | 20 | 1,298 | >100ª | —^{b} | no aeration; N = 4% | ^{b} |
| tower stripping | 10.4 | 42 | 2,834 | 98 | 46.3 | air flowrate = 70,000 L h⁻¹ | ^{c} |
| with no circulation | 9 | 75 | 2,244 | 91 | — | | ^{d} |
| absorption | | | | | | N = 4 % | ^{d} |
| tower stripping | 11.9 | 45.8 | 61.04 | 91 | 8 | | ^{e} |
| with no circulation | 12 | 25 | 2,500 | 99 | 178 | air flowrate = 720 L min⁻¹ | ^{f} |
| | 10.5 | 30 | 521~681 | 66.5~74.9 | 194~246 | | ^{g} |
| aeration stripping | 12 | 20 | 2,086 | 98 | 1,274 | air flowrate = 1,800 L h⁻¹ | ^{h} |
| with acid-base | | | | | | | |
| reaction | | | | | | | |
| absorption with | | | | 98 | 200 | N = 20% | ^{h} |
| acid-base reaction | | | | | | | |

^{a}Kim, et al., 2021.
^{b}Laureni, M.; Palatsi, J.; Llovera, M.; Bonmat, A. “Influence of Pig Slurry Characteristics on Ammonia Stripping Efficiencies and Quality of the Recovered Ammonium-Sulfate Solution,” J. Chem. Technol. Biotechnol. 88, 1654-1662 (2013).
^{c}Wang, Y.; Pelkonen, M.; Kotro, M. “Treatment of High Ammonium-Nitrogen Wastewater from Composting Facilities by Air Stripping and Catalytic Oxidation,” Water Air Soil Pollut. 208, 259-273 (2010).
^{d}Menkveld, H. W. H.; Broeders, E. “Recovery of Ammonia from Digestate as Fertilizer,” Water Practice & Technology 13, 382-387 (2018).
^{e}Zangeneh, A.; Sabzalipour, S.; Takdatsan, A.; Yengejeh, R. J.; Khafaie, M. A. “Ammonia Removal form Municipal Wastewater by Air Stripping Process: An Experimental Study,” South African Journal of Chemical Engineering 36, 134-141 (2021).
^{f}Ozyonar, F.; Karagozoglu, B.; Kobya, M. “Air Stripping of Ammonia from Coke Wastewater,” JESTECH, 15(2), 85-91, (2012).
^{g}Zou, M.; Dong, H.; Zhu, Z.; Zhan, Y. “Optimization of Ammonia Stripping of Piggery Biogas Slurry by Response Surface Methodology,” Int. J. Environ. Res. Public Health 2019, 16, 3819; doi: 10.3390/ijerph16203819.
^{h}This invention.

### EXAMPLE 7

### Sensitivity Analysis

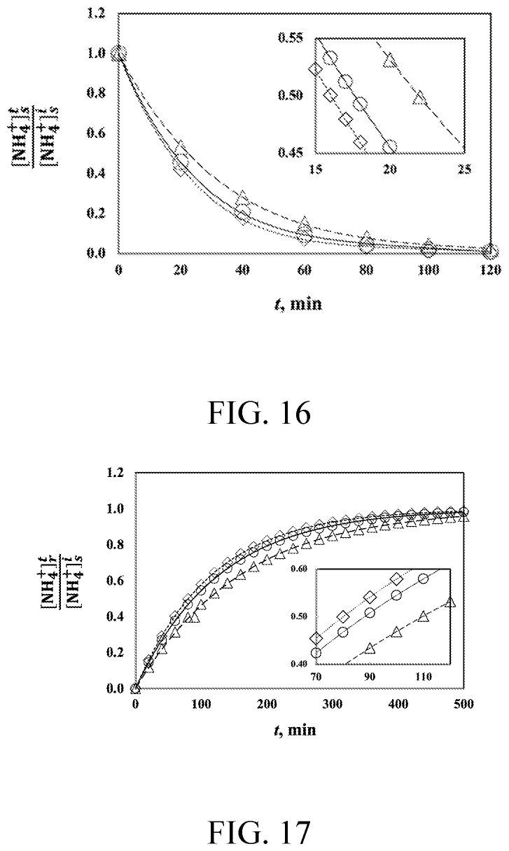

Turning now to FIG. 16 the sensitivity analysis of the normalized NH₄⁺ concentration of the stripping process,

$$\frac{{[ {NH}_{4}^{+} ]}_{s}^{t}}{{[ {NH}_{4}^{+} ]}_{s}^{i}} ,$$

to the stripping optimization variables

$$\frac{{Q}_{G , s} {H}_{s}}{{V}_{L , s}}$$

and K_{L,s}aᵣ in the mass transfer rate per unit volume, σₛ, when

$${K}_{L , s} {a}_{s} \times \frac{1}{{Q}_{G , s} {H}_{s}} = 0.5 ( ○ ) ,$$

1(Δ), and 2 (⋄) is displayed. The plots in the inset showing the range of

$$\frac{{[ {NH}_{4}^{+} ]}_{s}^{t}}{{[ {NH}_{4}^{+} ]}_{s}^{i}}$$

between 0.45 and 0.55 and the time between 15 min and 25 min depict the difference in the dependencies of

$$\frac{{[ {NH}_{4}^{+} ]}_{s}^{t}}{{[ {NH}_{4}^{+} ]}_{s}^{i}}$$

on the two combined variables. The time to reduce

$$\frac{{[ {NH}_{4}^{+} ]}_{s}^{t}}{{[ {NH}_{4}^{+} ]}_{s}^{i}}$$

by half is about 38% faster when K_{L,s}aₛ is twice as much as

$$\frac{{Q}_{G , s} {H}_{s}}{{V}_{L , s}}$$

when the two optimization variables share the same value. On the other hand, the time to reduce

$$\frac{{[ {NH}_{4}^{+} ]}_{s}^{t}}{{[ {NH}_{4}^{+} ]}_{s}^{i}}$$

by half is about 22% faster when

$$\frac{{Q}_{G , s} {H}_{s}}{{V}_{L , s}}$$

is twice as much as K_{L,s}aₛ when compared to when the two optimization variables are the same. Hence, it appears that it is more effective to adjust K_{L,s}aₛ than to adjust

$$\frac{{Q}_{G , s} {H}_{s}}{{V}_{L , s}}$$

in to increase σₛ. It is also important to observe that increasing either one optimization variable relative to the other raises the mass transfer rate compared to when both optimization variables are the same.

Looking now to FIG. 17, the sensitivity analysis of the normalized NH₄⁺ concentration of the recovery process,

$$\frac{{[ N {H}_{4}^{+} ]}_{r}^{t}}{{[ N {H}_{4}^{+} ]}_{s}^{i}} ,$$

to the recovery optimization variables

$$\frac{{[ N {H}_{4}^{+} ]}_{r}^{t}}{{[ N {H}_{4}^{+} ]}_{s}^{i}} ,$$

and K_{L,r}aᵣ in the transfer rate per unit volume, σᵣ, when

$$\frac{{[ N {H}_{4}^{+} ]}_{r}^{t}}{{[ N {H}_{4}^{+} ]}_{s}^{i}} ,$$

1(Δ), and 2 (⋄) are displayed. The plots in the inset showing the range of

$$\frac{{[ N {H}_{4}^{+} ]}_{r}^{t}}{{[ N {H}_{4}^{+} ]}_{s}^{i}}$$

between 0.40 and 0.60 and the time between 70 min and 120 min clearly depict the contrast in the dependencies of

$$\frac{{[ N {H}_{4}^{+} ]}_{r}^{t}}{{[ N {H}_{4}^{+} ]}_{s}^{i}}$$

on the two optimization variables. The time to reduce

$$\frac{{[ N {H}_{4}^{+} ]}_{r}^{t}}{{[ N {H}_{4}^{+} ]}_{s}^{i}}$$

by half is about 38% faster when K_{L,r}aᵣ is twice as much as

$$\frac{{Q}_{G , r} {H}_{r}}{{V}_{L , r}}$$

when the two optimization variables are the same. On the other hand, the time to reduce

$$\frac{{[ N {H}_{4}^{+} ]}_{r}^{t}}{{[ N {H}_{4}^{+} ]}_{s}^{i}}$$

by half is about 11% faster when

$$\frac{{Q}_{G , r} {H}_{r}}{{V}_{L , r}}$$

is twice as much as K_{L,s}aₛ when the two optimization variables are the same. Hence, it appears that it is more effective to adjust K_{L,r}aᵣ than

$$\frac{{Q}_{G , r} {H}_{r}}{{V}_{L , r}}$$

to increase σᵣ. It is also important to observe that increasing either one optimization variable relative to the other raises the mass transfer rate compared to when both optimization variables are the same.

### EXAMPLE 8

### Prior Art Liquefaction of NH₃ Gas

The liquefaction of the NH₃ gas recovered from ADL was performed in this EXAMPLE 8 by two methods: one described in U.S. Pat. No. 11,364,463 and one according to the systems and methods disclosed herein. First, the method described in U.S. Pat. No. 11,364,463 will be examined.

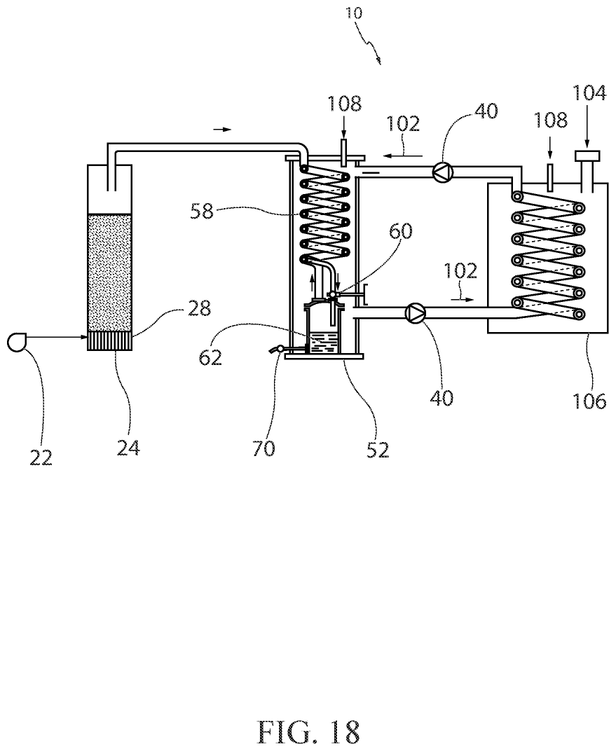

Brining our attention now to FIG. 18, the experimental apparatus for the NH₃ liquefaction based on the method described in U.S. Pat. No. 11,364,463 is illustrated. 2 L of ADL was placed in the stripping column 24, and pH was adjusted to 9. Aeration was conducted under the same condition as EXAMPLE 2 via air diffusers 28 and an air pump 22. The aerated gases were sent to a stainless-steel coiled pipe 58 connected to a liquid receiver 68 at the bottom inside the liquefaction device 52. Inside the liquefaction device 52, a coolant 102 continuously circulates to maintain the temperature inside below −70° C., but above −50° C. Since water freezes at these temperatures, despite U.S. Pat. No. 11,364,463's recommendation to use such a coolant, iso-propanol was used as the coolant 102 which was pumped by a pneumatic pump 40 from a cryogenic storage 106 to and out of the liquefaction device 52. Dry ice 104 was added to the cryogenic storage 106 to maintain the temperature. The internal temperatures of the liquefaction device 52 and the cryogenic storage 106 were monitored by a thermocouple thermometer 108. The gas release valve 60 was left open to release the other gases, N₂ and O₂. Liquid NH₃ was collected in a liquid receptacle 68 before being discharged through a liquid discharge outlet 70.

The initial NH₄⁺ concentration was 2,086 mg L⁻¹ and the volume was 2 L. With the 50% removal yield, found in EXAMPLE 2, it was expected to recover about 2 g of liquid NH₃. However, as soon as the aeration started, a pungent smell emerged from the gas release valve.

Without a trace of liquid and the characteristic smell of the NH₃ gas from the gas release valve, it was observed that the stripped NH₃ gas came through the coiled pipe without being liquefied despite the thermometer showing −60° C. inside the liquefaction device 52. It was suspected that the other gases such as N₂ and O₂, and possibly CO₂ interfered with the liquefaction of the stripped NH₃ gas, preventing the contact of the NH₃ gas with the coolant through the coiled pipe 58.

### EXAMPLE 9

### Liquefaction of NH₃ Gas According to the Present Disclosure

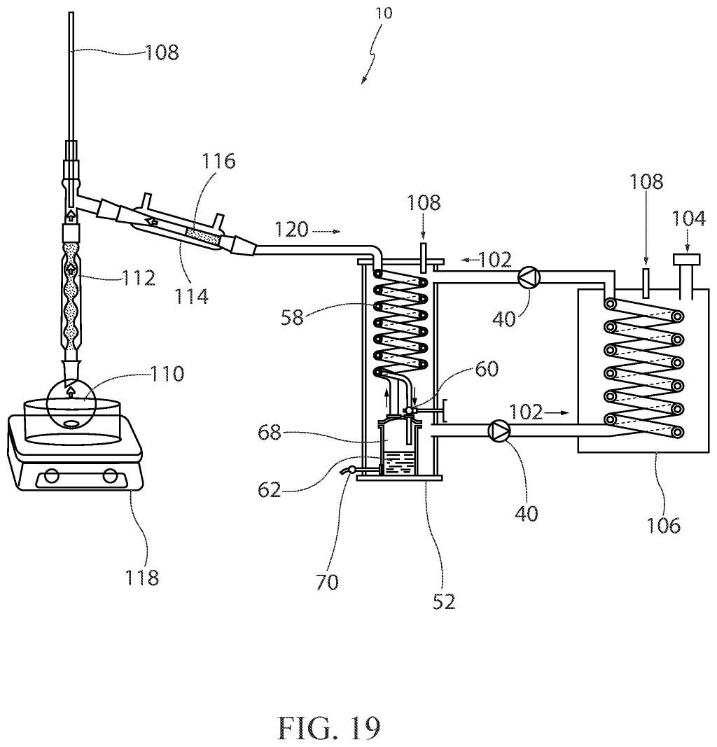

Looking now to FIG. 19, a bench-scale setup for the second liquefaction experiment according to the methods and systems disclosed herein is illustrated. A boiling round flask 110 was connected to two serial condensers, a water vapor condenser 112 and a moisture removal condenser 114 incorporating a desiccant 116, attached to the same liquefaction device 52 as that used for EXAMPLE 8. 500 mL of (NH₄)₂SO₄ (19.1% (NH₃)) solution produced by absorbing the stripped NH₃ gas in EXAMPLE 6 was heated at 70° C. inside the round flask 110 via a heating mantle 118 generating bubbles on the solution surface indicating the gas evaporation. The boiling point of NH₃ is−33.3° C. Hence, the liquid NH₃ was easily vaporized, but the evaporated NH₃ gas was also pushed towards the liquefaction device by the thermal energy. The temperature was measured with a thermometer 108. The evaporated mixture 120 was sent to the liquefaction device 52. The liquefaction device 52 was operated in the same way as was the case for EXAMPLE 8, incorporating similar features such as the coiled pipe 58, thermometers 108, liquid receptacle 68, liquid discharge outlet 70, gas release valve 60, coolant 102, pneumatic pumps 40, cryogenic storage 106, and dry ice 104.

After the bubbling of the solution inside the boiling flask 110 ceased, the circulation of the coolant 102 inside the liquefaction device 52 continued for another 30 min. Then, the coolant 102 circulation was stopped, and the liquid outlet valve 70 was released. The liquid NH₃ was discharged, and its volume was measured by a graduate cylinder. The collected volume was 111 mL which was equivalent to 87.6 g. A 500 mL of 19.1% NH₃ solution should yield 95.7 g of liquid NH₃ in principle with a density of 0.73 g mL⁻¹ for liquid NH₃. Hence, the NH₃ recovery efficiency was 91.5%. The difference between this experimental setup and EXAMPLE 8 is that the NH₄⁺ concentration in the solution, from which the NH₃ gas is to be recovered, increased by two orders of magnitude in EXAMPLE 9 when compared to EXAMPLE 8. Very little other gases such as N₂ and O₂ were present in the evaporated gas. As a result, a high flux of NH₃ gas enters the liquefaction device with very few interferences by other gases and therefore, it is easier for condensation to occur in EXAMPLE 9.

While the present invention has been described with regards to particular embodiments, it is recognized that additional variations of the present invention may be devised without departing from the inventive concept.

What is claimed is:

1. A method of producing liquid ammonia (NH₃) from wastewater containing ammonium (NH₄⁺), comprising the steps of:
supplying wastewater, a BrØnsted base, a BrØnsted acid and water;
supplying a stripping column equipped with one or more air diffusers, a recovery column equipped with one or more air diffusers, an evaporator, and, a condenser; the stripping column, recovery column, evaporator and condenser being in fluid communication;
mixing, in the stripping column, the wastewater with the BrØnsted base to form a stripping mixture, the BrØnsted base being operative to react with ammonium ions present in the wastewater to produce ammonia gas and other gasses in the stripping mixture;
stripping, in the stripping column, the ammonia from the stripping mixture by aerating the stripping mixture to produce ammonia gas and other gasses, wherein the mass transfer rate per unit volume of the conversion of ammonia in the stripping mixture to ammonia gas is at least 0.034 min⁻¹;
recovering, in the recovery column, the ammonia gas by absorbing the ammonia gas into a recovery solution comprising the BrØnsted acid and water, wherein the mass transfer rate per unit volume of the ammonia gas to the recovery solution is at least 0.006 min⁻¹, the recovery solution and ammonia gas absorbed therein defining a liquid ammonia product;
heating, in the evaporator, the liquid ammonia product to form an evaporated mixture comprising substantially ammonia gas; and
condensing, in the condenser, the evaporated mixture into liquid ammonia.

2. A method of producing liquid ammonia (NH₃) from wastewater containing ammonium (NH₄⁺), comprising the steps of:
supplying wastewater, a BrØnsted base, a BrØnsted acid and water;
supplying a stripping column equipped with one or more air diffusers, a recovery column equipped with one or more air diffusers, an evaporator, and, a liquefaction device; the stripping column, recovery column, evaporator and liquefaction device being in fluid communication;
mixing, in the stripping column, the wastewater with the BrØnsted base to form a stripping mixture, the BrØnsted base being operative to react with ammonium ions present in the wastewater to produce ammonia gas and other gasses in the stripping mixture;
stripping, in the stripping column, the ammonia from the stripping mixture by aerating the stripping mixture to produce ammonia gas and other gasses; and
recovering, in the recovery column, the ammonia gas by absorbing the ammonia gas into a recovery solution comprising the BrØnsted acid and water, the recovery solution and ammonia gas absorbed therein defining an ammonia product;
heating, in the evaporator, the ammonia product to form an evaporated mixture comprising substantially ammonia gas; and
liquefying, in the liquefaction device, the evaporated mixture into liquid ammonia (NH₃).

3. The method of producing liquid ammonia (NH₃) from wastewater containing ammonium (NH₄₊) of claim 2, further comprising the step of filtering the wastewater so as to at least partially separate any solid components from the wastewater.

4. The method of producing liquid ammonia (NH₃) from wastewater containing ammonium (NH₄⁺) of claim 2, further comprising repeating the steps stripping ammonia gas from the stripping mixture and, absorbing the ammonia gas in the recovery solution, until the recovery solution is saturated with the ammonia gas.

5. The method of producing liquid ammonia (NH₃) from wastewater containing ammonium (NH₄⁺) of claim 2, wherein the BrØnsted base is selected from the group consisting of Ca(OH)₂, CaCO₃, Ca(HCO₃)₂, NaOH, Na₂CO₃, Na₂(HCO₃)₂, KOH, K₂CO₃, and K(HCO₃)₂.

6. The method of producing liquid ammonia (NH₃) from wastewater containing ammonium (NH₄⁺) of claim 2, wherein the BrØnsted acid is selected from the group consisting of HNO₃, H₂SO₄, H₃PO₄, C₆H₈O₅, formic acid, potassium acetate, trisodium phosphate, and sodium acetate.

7. The method of producing liquid ammonia (NH₃) from wastewater containing ammonium (NH₄⁺) of claim 2, wherein a mole of an anion of the BrØnsted base is at least stoichiometric to a mole of the ammonium ions in the wastewater.

8. The method of producing liquid ammonia (NH₃) from wastewater containing ammonium (NH₄⁺) of claim 2, wherein a mole of an anion of the BrØnsted base is at least 10% more than stoichiometric to a mole of the ammonium ions in the wastewater.

9. The method of producing liquid ammonia (NH₃) from wastewater containing ammonium (NH₄⁺) of claim 2, wherein a mole of a cation of the BrØnsted acid is at least stoichiometric to a mole of the stripped ammonia gas.

10. The method of producing liquid ammonia (NH₃) from wastewater containing ammonium (NH₄⁺) of claim 2, wherein a mole of a cation of the BrØnsted acid is at least 10% more than stoichiometric to a mole of the stripped ammonia gas.

11. The method of producing liquid ammonia (NH₃) from wastewater containing ammonium (NH₄⁺) of claim 2, wherein during the step of stripping the ammonia gas from the stripping mixture, the mass transfer rate per unit volume of the conversion of ammonia to ammonia gas is at least 0.034 min⁻¹.

12. The method of producing liquid ammonia (NH₃) from wastewater containing ammonium (NH₄⁺) of claim 2, wherein during the step of recovering the ammonia gas by absorbing the ammonia gas into a recovery solution, the mass transfer rate per unit volume of the ammonia gas to the recovery solution is at least 0.006 min⁻¹.

13. The method of producing liquid ammonia (NH₃) from wastewater containing ammonium (NH₄⁺) of claim 2, wherein the value of a liquid-to-gas mass transfer coefficient (K_{L,s}) multiplied by an interface area per volume of liquid (aₛ) is not be lower than
$$\frac{{Q}_{G , s} {H}_{s}}{{V}_{L , s}}$$
where Q_{G,s}, V_{L,s} and Hₛ are the air flowrate, the volume, and Henry's law constant, respectively.

14. The method of producing liquid ammonia (NH₃) from wastewater containing ammonium (NH₄⁺) of claim 2, wherein a gas-to-liquid mass transfer coefficient (K_{L,r}) multiplied by an interface area per volume of liquid (a r) is not be lower than
$$\frac{{Q}_{G , r} {H}_{r}}{{V}_{L , r}}$$
where Q_{G,r}, V_{L,r} and Hᵣ are the air flowrate, the volume, and Henry's law constant, respectively.

15. The method for producing liquid ammonia (NH₃) from wastewater containing ammonium (NH₄⁺) of claim 2, further including the step of stripping NH₃ and CO₂ gases from the stripping mixture and absorbing these gasses in the recovery solution to produce ammonium bicarbonate as an organic fertilizer.

16. The method for producing liquid ammonia (NH₃) from wastewater containing ammonium (NH₄⁺) of claim 2 by applying a pressure to the evaporated ammonia gas.

17. The method for producing liquid ammonia (NH₃) from wastewater containing ammonium (NH₄⁺) of claim 2, further comprising the step of reacting the liquid ammonia with a CO₂ supply to produce urea.

18. The method for producing liquid ammonia (NH₃) from wastewater containing ammonium (NH₄⁺) of claim 17, wherein the CO₂ supply is selected from the group consisting of CO₂ gas generated by anaerobic digestion of organic wastes, CO₂ gas sequestered from an industrial plant, and CO₂ gas captured from the stripping column.

19. An apparatus for producing liquid ammonia (NH₃) from wastewater containing ammonium (NH₄⁺) comprising:
a stripping column equipped with one or more air diffusers, a recovery column equipped with one or more air diffusers, an evaporator; and, a liquefaction device; the stripping column, recovery column, evaporator and liquefaction device being in fluid communication;
wherein, in the stripping column wastewater is mixed with a BrØnsted base to form a stripping mixture, the BrØnsted base being operative to react with ammonium ions present in the wastewater to produce ammonia gas and other gasses in the stripping mixture;
wherein, the one or more air diffusers are located in the base of the stripping column and function to aerate the stripping mixture to release the ammonia gas and other gasses contained therein; and
wherein, in the recovery column, the ammonia gas is absorbing into a recovery solution comprising a BrØnsted acid and water, the recovery solution and ammonia gas absorbed therein defining an ammonia product;
wherein, in the evaporator, the ammonia product is heated to form an evaporated mixture comprising substantially ammonia gas; and
wherein, in the liquefaction device, the evaporated mixture is cooled to form liquid ammonia (NH₃).

20. The apparatus for producing liquid ammonia (NH₃) from wastewater containing ammonium (NH₄⁺) of claim 19, wherein at least one of the one or more air diffusers in the stripping column or recovery column is selected from the group consisting of a sintered stone diffuser, a membrane diffuser, a sparger diffuser, or combinations thereof.

21. The apparatus for producing liquid ammonia (NH₃) from wastewater containing ammonium (NH₄⁺) of claim 19, wherein at least one of the one or more air diffusers has an orifice diameter of 10 mm or less and a surface area per length in the range of 0.5-3 inch² inch⁻¹.

22. The apparatus for producing liquid ammonia (NH₃) from wastewater containing ammonium (NH₄⁺) of claim 19, wherein the number of the one or more air diffusers in the stripping column or recovery columns is the square of the diameter of the respective column in inches.

23. The apparatus for producing liquid ammonia (NH₃) from wastewater containing ammonium (NH₄⁺) of claim 19, wherein at least one of the one or more air diffusers in the stripping column or the recovery columns is a sparger pipe diffuser, and wherein the number of the one or more air diffusers is equal to the diameter of the respective column in inches.

24. The apparatus for producing liquid ammonia (NH₃) from wastewater containing ammonium (NH₄⁺) of claim 19, wherein at least one of the one or more air diffusers in the stripping column or recovery columns is a sparger pipe diffuser, and wherein the number of the one or more air diffusers is equal to one inch more than the value of the diameter of the respective column diameter in inches.

25. The apparatus for producing liquid ammonia (NH₃) from wastewater containing ammonium (NH₄⁺) of claim 19, wherein the stripping column further comprises one or more sub-columns each equipped with one or more air diffusers, the one or more sub-columns having a diameter in the rage of 1 in to 3 in, the one or more sub-columns being operative to increase the efficiency of the step of stripping the ammonia gas from the filtered wastewater.

26. The apparatus for producing liquid ammonia (NH₃) from wastewater containing ammonium (NH₄⁺) of claim 19, wherein an air pump is placed between the stripping column and the recovery column to increase the flow rate of ammonia gas to the recovery column.

27. The apparatus for producing liquid ammonia (NH₃) from wastewater containing ammonium (NH₄⁺) of claim 19, wherein the liquefaction device uses a coolant selected from the group consisting of iso-propanol, acetone, 1-, or 2-butanol, 2-butanone, ethanol, diethyl ether, heptane, n-hexane, pentane, 1-propanol, tetrahydrofuran, and triethyl amine.

28. The apparatus for producing liquid ammonia (NH₃) from wastewater containing ammonium (NH₄⁺) of claim 19, wherein the coolant is supplied to the liquefaction device from a cryogenic storage tank, the cryogenic storage tank having a cryogenic substance, the cryogenic substance comprising liquid nitrogen.

29. The apparatus for producing liquid ammonia (NH₃) from wastewater containing ammonium (NH₄⁺) of claim 19, wherein the stripping column or the recovery column further includes a mesh screen operative to break up air bubbles rising up the column from the one or more air diffusers.

30. The apparatus for producing liquid ammonia (NH₃) from wastewater containing ammonium (NH₄⁺) of claim 19, wherein the said ammonia product in the recovery column is a renewable N fertilizer.

31. The apparatus for producing liquid ammonia (NH₃) from wastewater containing ammonium (NH₄⁺) of claim 19, wherein the stripping column comprises a first stripping column fluidly coupled to a second stripping column, wherein the process of stripping ammonia gas from wastewater takes place in both the first and the second stripping columns, and wherein a valve is operative to direct the flow of wastewater from the first stripping column to the second stripping column when the first stripping column reaches a predetermined volume.

32. The apparatus for producing liquid ammonia (NH₃) from wastewater containing ammonium (NH₄⁺) of claim 19, wherein a pressure is applied to the evaporated ammonia gas for liquefaction.

33. The apparatus for producing liquid ammonia (NH₃) from wastewater containing ammonium (NH₄⁺) of claim 19, wherein the recovery column comprises a first recovery column fluidly coupled to a second recovery column, wherein the process of recovering ammonia gas in the recovery solution takes place in both the first and the second recovery columns, and wherein a valve is operative to direct the flow of ammonia gas from the first recovery column to the second recovery column when the saturation level of ammonia gas in the recovery solution of the first recovery column reaches a predetermined level.

34. A method of producing an ammonia product from wastewater containing ammonium (NH₄⁺), comprising the steps of:
supplying wastewater, a BrØnsted base, a BrØnsted acid and water;
supplying a stripping column equipped with one or more air diffusers and a recovery column equipped with one or more air diffusers; the stripping column and recovery column, being in fluid communication;
mixing, in the stripping column, the wastewater with the BrØnsted base to form a stripping mixture, the BrØnsted base being operative to react with ammonium ions present in the wastewater to produce ammonia gas and other gasses in the stripping mixture;
stripping, in the stripping column, the ammonia from the stripping mixture by aerating the stripping mixture to produce ammonia gas and other gasses; and
recovering, in the recovery column, the ammonia gas by absorbing the ammonia gas into a recovery solution comprising the BrØnsted acid and water, the recovery solution and ammonia gas absorbed therein defining an ammonia product.

35. The method of producing an ammonia product from wastewater containing ammonium (NH₄⁺) of claim 34, wherein the ammonia product is an N fertilizer having a nitrogen concentration of at least 15%.

36. The method of producing an ammonia product from wastewater containing ammonium (NH₄⁺) of claim 34, wherein the value of a liquid-to-gas mass transfer coefficient (K_{L,s}) multiplied by an interface area per volume of liquid (aₛ) is not be lower than
$$\frac{{Q}_{G , s} {H}_{s}}{{V}_{L , s}}$$
where Q_{G,s}, V_{L,s} and Hₛ are the air flowrate, the volume, and Henry's law constant, respectively.

37. The method of producing an ammonia product from wastewater containing ammonium (NH₄⁺) of claim 34, wherein a gas-to-liquid mass transfer (K_{L,r}) multiplied by an interface area per volume of liquid (aᵣ) is not be lower than
$$\frac{{Q}_{G , r} {H}_{r}}{{V}_{L , r}}$$
where Q_{G,r}, V_{L,r} and Hᵣ are the air flowrate, the volume, and Henry's law constant, respectively.

38. An apparatus for producing an ammonia product from wastewater containing ammonium (NH₄⁺) comprising:
a stripping column equipped with one or more air diffusers and a recovery column equipped with one or more air diffusers; the stripping column and recovery column being in fluid communication;
wherein, in the stripping column wastewater is mixed with a BrØnsted base to form a stripping mixture, the BrØnsted base being operative to react with ammonium ions present in the wastewater to produce ammonia gas and other gasses in the stripping mixture;
wherein, the one or more air diffusers are located in the base of the stripping column and function to aerate the stripping mixture to release the ammonia gas and other gasses contained therein; and
wherein, in the recovery column, the ammonia gas is absorbing into a recovery solution comprising a BrØnsted acid and water, the recovery solution and ammonia gas absorbed therein defining an ammonia product.

39. The apparatus for producing an ammonia product from wastewater containing ammonium (NH₄⁺) of claim 38, wherein the ammonia product is an N fertilizer having a nitrogen concentration of at least 15%.

40. The apparatus for producing an ammonia product from wastewater containing ammonium (NH₄⁺) of claim 38, wherein at least one of the one or more air diffusers has an orifice diameter of 10 mm or less and a surface area per length in the range of 0.5-3 inch² inch⁻¹.

41. The apparatus for producing an ammonia product from wastewater containing ammonium (NH₄⁺) of claim 38, wherein the number of the one or more air diffusers in the stripping column or recovery columns is the square of the diameter of the respective column in inches.

42. The apparatus for producing an ammonia product from wastewater containing ammonium (NH₄⁺) of claim 38, wherein at least one of the one or more air diffusers in the stripping column or the recovery columns is a sparger pipe diffuser, and wherein the number of the one or more air diffusers is equal to the diameter of the respective column in inches.

43. The apparatus for producing an ammonia product from wastewater containing ammonium (NH₄⁺) of claim 38, wherein at least one of the one or more air diffusers in the stripping column or recovery columns is a sparger pipe diffuser, and wherein the number of the one of more air diffusers is equal to one inch more than the value of the diameter of the respective column diameter in inches.
